(19) United States
(12) Patent Application Publication
(10) Pub. No.: US 2025/0294573 A1
(43) Pub. Date: Sep. 18, 2025

(54) TECHNIQUES FOR RECYCLING ANTENNAS FOR MULTI-COMPONENT CARRIER (CC) OPERATIONS IN WIRELESS COMMUNICATIONS

(71) Applicant: QUALCOMM Incorporated, San Diego, CA (US)

(72) Inventors: Kianoush HOSSEINI, San Diego, CA (US); Mostafa KHOSHNEVISAN, San Diego, CA (US); Kazuki TAKEDA, Tokyo (JP); Jing LEI, San Diego, CA (US)

(21) Appl. No.: 18/608,708

(22) Filed: Mar. 18, 2024

(51) Int. Cl. H04W 72/231; H04B 7/06; H04L 5/00; H04W 76/20

(52) U.S. Cl. CPC H04W 72/231; H04B 7/0626; H04L 5/0051; H04W 76/20

(57) ABSTRACT

Aspects described herein relate to recycling transmit or receive antennas from one band to another and accordingly modifying certain operations, which may include channel state information (CSI) reporting, sounding reference signal (SRS) transmission, and/or the like.

### FIELD OF THE DISCLOSURE

Aspects of the present disclosure relate generally to wireless communication systems, and more particularly, to reusing unused antennas for wireless communications.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to receive a configuration for a first antenna of the apparatus to receive downlink signaling in a first band, receive, from a network node, an indication to use the first antenna, during a time period, along with a second antenna of the apparatus to receive downlink signaling in a second band, and receive, during the time period, downlink signaling in the second band using the first antenna and the second antenna.

In another aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to receive one or more configurations indicating resources for transmitting SRSs to a network node in a first band using each of multiple combinations of multiple antennas, wherein at least one combination of the multiple combinations is based on switching one or more of the multiple antennas that are configured for a second band to the first band, and transmit, to the network node and using at least one of the multiple combinations, a SRS in the first band based on switching the one or more of the multiple antennas that are configured for the second band for use in the first band.

In another aspect, a method for wireless communication at a UE is provided that includes receiving a configuration for a first antenna of the UE to receive downlink signaling in a first band, receiving, from a network node, an indication to use the first antenna, during a time period, along with a second antenna of the UE to receive downlink signaling in a second band, and receiving, during the time period, downlink signaling in the second band using the first antenna and the second antenna.

In another aspect, a method for wireless communication at a UE is provided that includes receiving one or more configurations indicating resources for transmitting SRSs to a network node in a first band using each of multiple combinations of multiple antennas, wherein at least one combination of the multiple combinations is based on switching one or more of the multiple antennas that are configured for a second band to the first band, and transmitting, to the network node and using at least one of the multiple combinations, a SRS in the first band based on switching the one or more of the multiple antennas that are configured for the second band for use in the first band.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for recycling antennas in multi-CC operations including channel state information (CSI) reporting, in accordance with aspects described herein;

FIG. 6 is a flow chart illustrating an example of a method for configuring a UE recycling antennas in multi-CC operations including CSI reporting, in accordance with aspects described herein;

FIG. 7 is a flow chart illustrating an example of a method for recycling antennas in multi-CC operations including sounding reference signal (SRS) transmission, in accordance with aspects described herein;

FIG. 8 is a flow chart illustrating an example of a method for configuring a UE recycling antennas in multi-CC operations including SRS transmission, in accordance with aspects described herein;

FIG. 9 is a flow chart illustrating an example of a method for a UE prioritizing communications where different numbers of antennas are configured, in accordance with aspects described herein;

FIG. 10 is a flow chart illustrating an example of a method for a network node prioritizing communications where different numbers of antennas are configured, in accordance with aspects described herein; and

FIG. 11 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to reusing unused antennas for multi-carrier operations in wireless communications. For example, a device, such as a user equipment (UE) in fifth generation (5G) new radio (NR) or other wireless communication technologies, can include multiple antennas for transmitting uplink communications and/or receiving downlink communications. In a specific example, third generation partnership project (3GPP) Release 16 specifies one transmit chain or two transmit chain switching between frequency bands, where a first frequency bands can use the transmit chain from a second frequency band to transmit uplink communications over the first frequency band with two transmit chains. 3GPP Release 16 defines a radio resource control (RRC) information element (IE), “uplinkTxSwitchingOption,” that can be set to a value “switchedUL” to indicate no simultaneous uplink transmission (e.g., one transmit chain is used for the first band and a different transmit chain is used for the second band), which is referred to herein as “Case 1.” “uplinkTxSwitchingOption” can also be set to a value “dualUL” to indicate simultaneous uplink transmission (e.g., both transmit chains are used for the second band), which is referred to herein as “Case 2.” In dualUL, for example, the first transmit chain for the first band is borrowed for the second band, such that the first transmit chain and the second transmit chain are used to transmit in the second band. 3GPP Release 17 provides an enhancement to enable UL multiple-input multiple-output (MIMO) in both bands with a total of two transmit chains. This allows the second transmit chain to be borrowed for the first band, such that the second transmit chain and the first transmit chain are used to transmit in the first band, which is referred to herein as “Case 3.”

In addition, in some examples, one or more ports can map to each transmit chain that is used. In Case 1, where the first and second transmit chains are used for the first and second band, respectively, one port can be assigned to each band or one port can be assigned to either one of the bands. In Case 2, where the first and second transmit chains are used for the second band, one or two ports can be assigned to the second band. In Case 3, where the first and second transmit chains are used for the second band, one or two ports can be assigned to the first band. In addition, transmit chain switching, as described above, can be beneficial in performing UL MIMO (or generally UL with a larger number of antennas, e.g., a single-port transmission with two antennas instead of one) in cases where some of the antennas on a component carrier (CC) of another band are idle. For example, antennas on the other band can be considered idle if, for a given time period (such as a slot), the communication direction of the other band (e.g., specified in a slot configuration) is uplink (“U”) but no uplink transmission is scheduled/configured or when the communication direction of the other band is downlink (“D”).

In some aspects described herein, a UE can recycle receive antenna (e.g., receive chains) across serving cells of different bands when the receive antennas are not being used in the different bands, which can allow for achieving throughput gains in receiving downlink (or sidelink) signaling via the receive antennas. Aspects described herein can relate to identifying potential issues that can arise when a UE is performing UL or DL antenna switching and associated solutions thereto. For example, when a UE is capable of switching transmit and/or receive antennas across different CCs, DL channel estimation and/or UL sounding reference signal (SRS) transmissions (for different purposes) may be inaccurate unless there is an understanding between a UE and network node on how these antennas are moved.

In one specific example, in downlink channel estimation in NR, a UE is configured with several channel state information (CSI) report configurations (up to 48), where each CSI report configuration is associated with one to three resource settings (e.g., resource setting for channel measurement report (CMR), for CMR and CSI-interference management (IM) or non-zero power (NZP)-interference measurement report (IMR), or for CMR and CSI-IM and NZP-IMR). Each resource setting can have one active resource set and/or each resource set can have one or more resources. A UE evaluates CSI corresponding to each CSI-RS resource and reports the best one along with CSI resource index (CRI). The reported metrics can include precoding matrix indicator (PMI), rank indicator (RI), layer indicator (LI), channel quality indicator (CQI), layer 1 (L1)-reference signal received power (RSRP), L1-signal-to-interference-and-noise ratio (SINR), etc.

Presently, in 5G NR where receive antennas are not recycled, the number of receive antennas is fixed in time, and the CSI reports associated with a given CSI report configuration are consistent across time. If the UE is capable of changing its number and/or configuration of receive antennas across CCs or bands, however, the CSI report can be impacted. For example, assuming a CSI report configuration with rank restriction of up to four, whether a UE is using four receive antennas or eight receive antennas at the time of measurement can impact the results—a UE may be more likely to report rank four if a UE is using a larger number of antennas. The disparity in the results may also impact downlink link adaptation, and hence, DL reception at the UE. The source of disparity can be dependent on the number of receive antennas that a UE used for CSI measurement and that used for downlink reception. Accordingly, some aspects described herein relate to configuring (e.g., for or by the UE) the number of receive antennas used in receiving CSI-RSs and/or corresponding downlink communications to improve process of CSI reports.

In another specific example, in 5G NR, SRS can be configured for different usages, such as antenna switching (for DL CSI acquisition), carrier switching (sounding CCs without UL), for non-codebook based (CB) physical uplink shared channel (PUSCH), beam management, positioning, etc. For antenna switching, a UE can indicate its capability as xTyR (where “x” is the number of transmit antennas and “y” is the number of receive antennas); x also indicates the number of SRS ports that can be sounded simultaneously, e.g., in the same symbol. A UE can be configured with an SRS resource set for a given usage (e.g., antenna switching). Depending on the value of x and y, a UE can be configured with y/x resources for transmitting SRS, where each resource can be used for the simultaneous sounding of x ports.

For example, where a UE is configured with two DL/UL cells with four transmit antennas in total, which can be assigned across the two UL CCs, in legacy systems, a UE can assign two antennas per CC. With UL transmit antenna switching, however, all four antenna could be moved to one CC, in some examples. Assuming that at a first time the UE is using all four antennas for UL channel sounding on CC0, and at a second time the UE is using all four antennas for UL channel sounding on CC1, at a third time, the UE may keep two antennas for transmission on CC1 and move the other two antennas for reception of DL from the network node on CC0. In this specific example, the network node can intend to use channel estimates from UL sounding for DL precoding of the DL transmission on CC0, but the network node may not know which UL/SRS ports are kept on CC1 and which ones are moved to CC0 for DL. Accordingly, some aspects described herein relate to configuring the UE to transmit SRS for various combinations of transmit and/or receive antennas that can be used in antenna switching.

In yet another specific example, for NCB PUSCH, a UE can use the associated CSI-RS for performing channel estimation, and then chooses how to precode its SRS port for UL when SRS resource set is configured for NCB PUSCH (e.g., based on a csi-RS field in the RRC-configured SRS-ResourceSet IE). A network node, using SRI field in the DCI, can indicate to the UE how to transmit PUSCH, where the SRI can point to the one or multiple of SRS resources UE used for UL sounding, and the UE can use the same ports (possibly with the same precoding) used for SRS transmission. To point to correct SRS resources using SRI, the network node may need to know which SRS ports are kept on the same CC (the antennas associated with other ports may be moved to another CC/band). As explained in examples above, SRS configuration for antenna switching can be dependent on the reported xTyR of the UE. For example, for a UE capable of xTyR in a given band, on the uplink CCs in this reported band, the UE performs SRS switching based on xTyR and hence is configured with appropriate SRS resources. When a UE is capable of receive or transmit antenna switching, however, xTyR may not be fixed (e.g., depending on the capability, either x or y or both could change across time). Accordingly, some aspects described herein relate to configuring the UE with a set of SRS resources that can cover different possibilities for setting x and y.

In accordance with aspects described herein, a number of antennas that can be used for antenna switching can be considered in reporting, or configuring reporting of, CSI, in configuring SRS transmission, etc. This can improve processing of CSI by a network node and/or can allow a network node to more effectively design a precoder for transmitting DL communications to a UE, both of which can improve effectiveness of downlink transmissions to the UE.

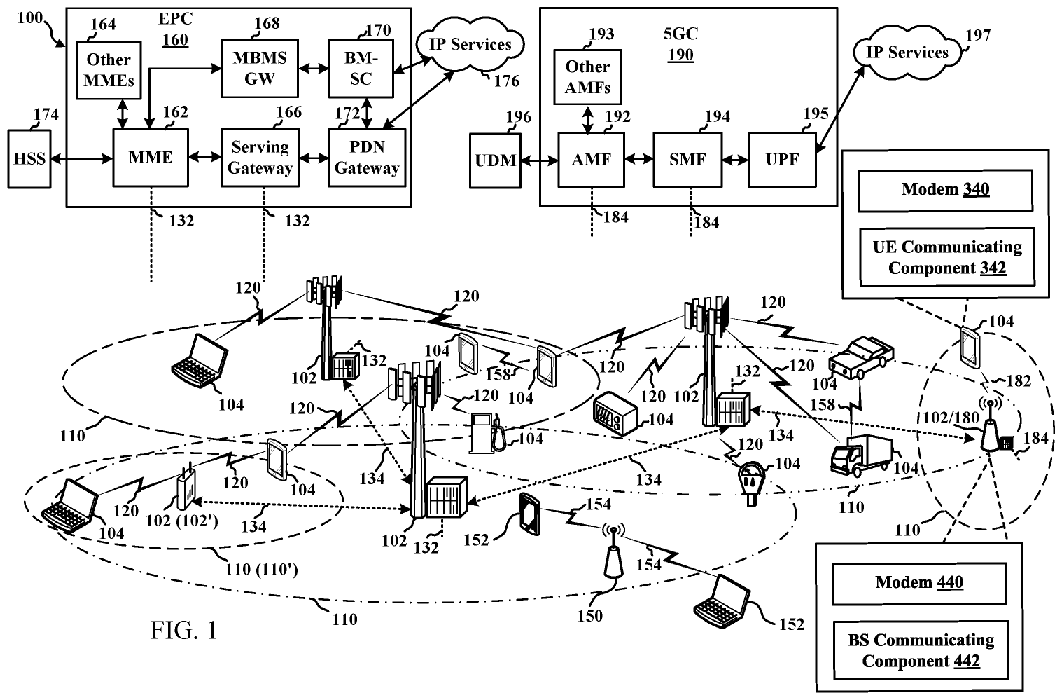

The described features will be presented in more detail below with reference to FIGS. 1-11.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for recycling antennas for multi-CC operations, in accordance with aspects described herein. In addition, some nodes may have a modem 440 and BS communicating component 442 for configuring UEs recycling antennas for multi-CC operations, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE communicating component 342 of a UE 104 can recycle antennas for multi-CC operations, such as for transmitting uplink (or sidelink) communications or receiving downlink (or sidelink) communications. In some examples, certain reference signal-based communications may be impacted by utilizing additional antennas or different antenna configurations. Accordingly, in some examples, BS communicating component 442 (of a base station 102/gNB 180 or another UE in sidelink communications) can configure the UE 104 with an indication of a number or configuration of antennas to use (or that the UE 104 can select to use) in transmitting uplink communications or receiving downlink communications, in accordance with various aspects described herein. In one example, BS communicating component 442 can configure the UE 104 to use multiple antennas to receive CSI-RSs from the base station 102. In this example, UE communicating component 342 can accordingly receive the configuration and receive and/or measure the CSI-RSs over the multiple antennas. In another example, BS communicating component 442 can configure the UE 104 with various SRS resources that the UE 104 can use to transmit SRS using various antenna configurations. In this example, UE communicating component 342 can accordingly receive the configuration and transmit the SRS for various antenna configurations over the associated SRS resources.

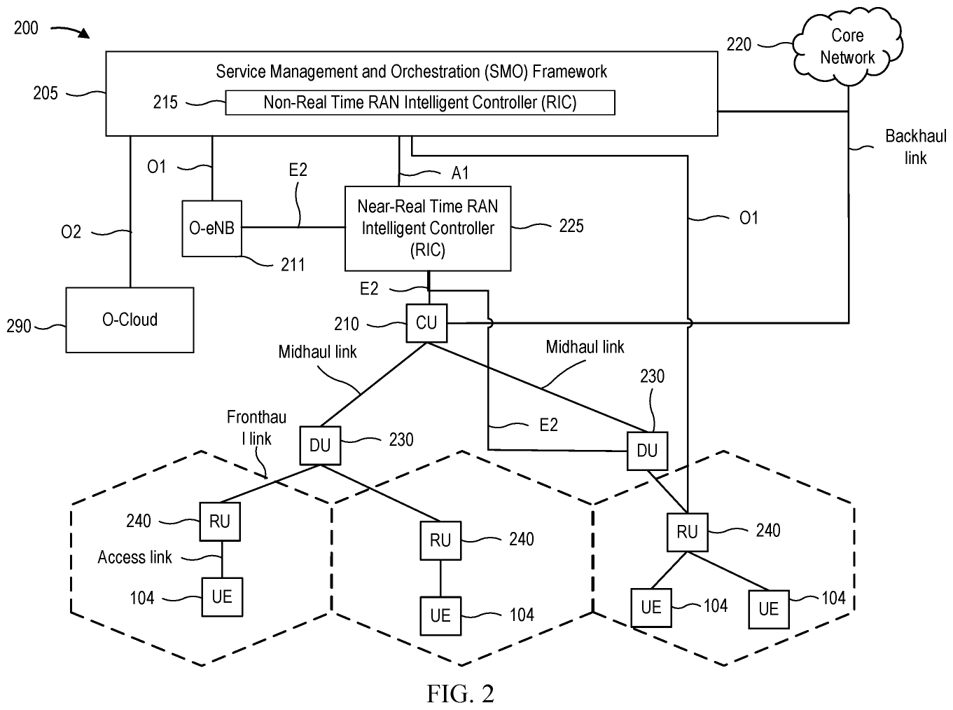

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

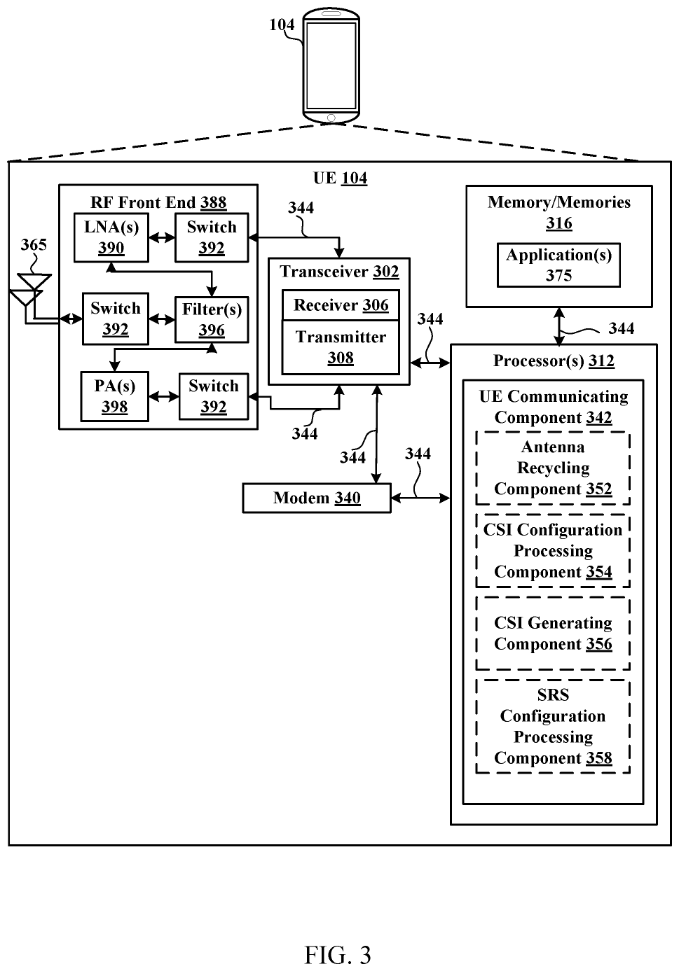

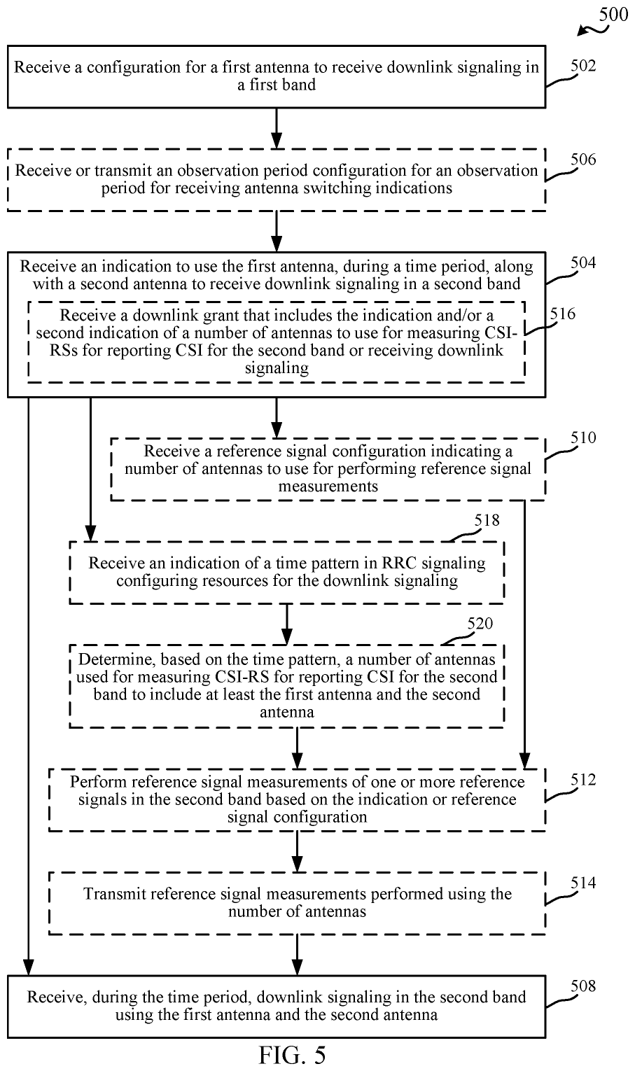

Turning now to FIGS. 3-11, aspects are depicted with reference to one or more components and one or more methods that may perform the actions or operations described herein, where aspects in dashed line may be optional. Although the operations described below in FIGS. 5-10 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or UE communicating component 342 for recycling antennas for multi-CC operations, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory/memories 316 may be configured to store data used herein and/or local versions of applications 375 or UE communicating component 342 and/or one or more of its subcomponents being executed by at least one processor 312. Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include an antenna recycling component 352 for using antennas assigned to a first band for communicating in a second band, a CSI configuration processing component 354 for receiving and processing a CSI configuration received from a base station (or another UE in sidelink communications), a CSI generating component 356 for generating, based on the CSI configuration, CSI for transmitting to the base station, and/or a SRS configuration processing component 358 for processing a SRS configuration received from a network node for determining resources over which to transmit SRS, in accordance with aspects described herein.

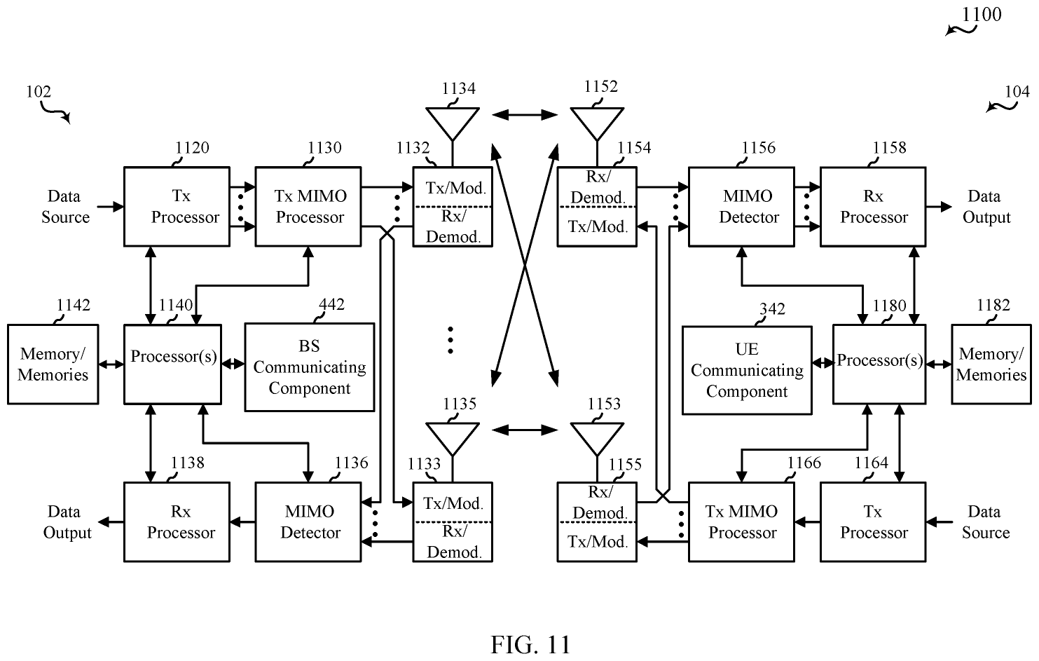

In an aspect, the processor(s) 312 may correspond to one or more of the processors described in connection with the UE in FIG. 11. Similarly, the memory/memories 316 may correspond to the one or more memories described in connection with the UE in FIG. 11.

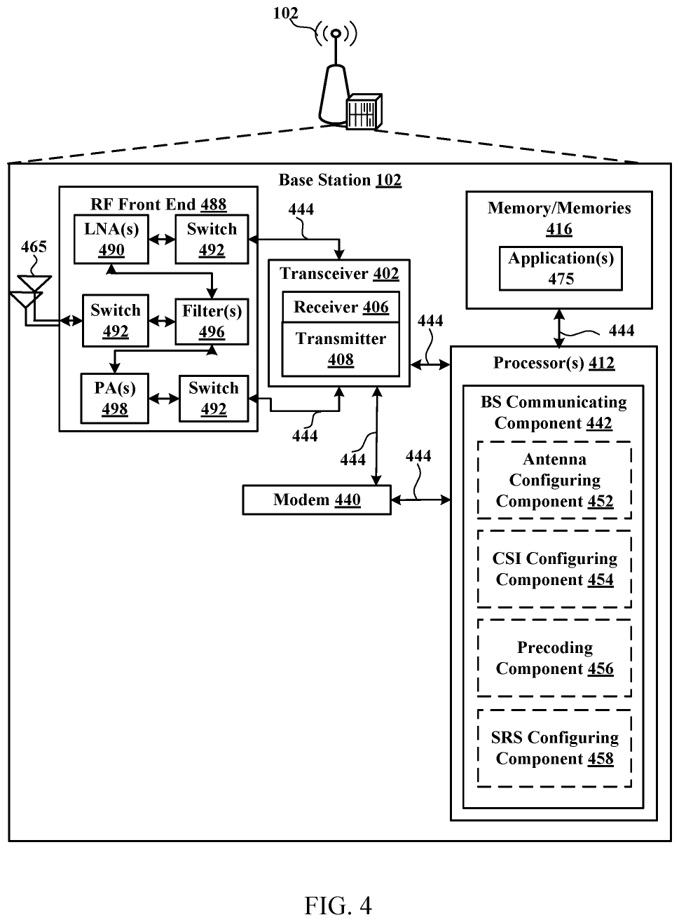

Referring to FIG. 4, one example of an implementation of base station 102 (e.g., a base station 102 and/or gNB 180, as described above) may include a variety of components, some of which have already been described above, but including components such as one or more processors 412 and one or more memories 416 and one or more transceivers 402 in communication via one or more buses 444. For example, the one or more processors 412 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 416 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 412, one or more memories 416, and one or more transceivers 402 may operate in conjunction with modem 440 and/or BS communicating component 442 for configuring UEs recycling antennas for multi-CC operations, in accordance with aspects described herein.

The transceiver 402, receiver 406, transmitter 408, one or more processors 412, memory/memories 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include an antenna configuring component 452 for configuring a UE 104 to use an antenna assigned to a first band to perform wireless communications in a second band, a CSI configuring component 454 for configuring the UE 104 to measure and/or report measurements of CSI-RSs received by the UE 104, a precoding component 456 for selecting or generating a precoder for transmitting downlink communications to the UE 104, and/or a SRS configuring component 458 for configuring a UE to transmit SRS over indicated resources, in accordance with aspects described herein.

In an aspect, the processor(s) 412 may correspond to one or more of the processors described in connection with the base station in FIG. 11. Similarly, the memory/memories 416 may correspond to the one or more memories described in connection with the base station in FIG. 11.

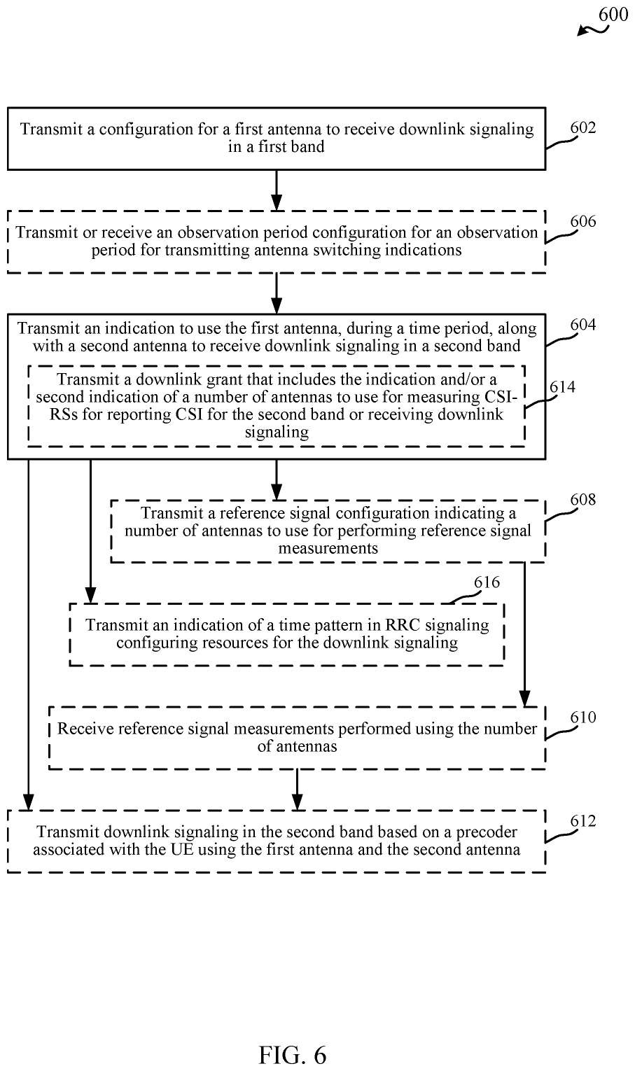

FIG. 5 illustrates a flow chart of an example of a method 500 for recycling antennas in multi-CC operations including CSI reporting, in accordance with aspects described herein. FIG. 6 illustrates a flow chart of an example of a method 600 for configuring a UE recycling antennas in multi-CC operations including CSI reporting, in accordance with aspects described herein. In an example, a UE 104 can perform the functions described in method 500 shown in FIG. 5 using one or more of the components described in FIGS. 1 and/or 3. In an example, a node scheduling the UE 104 with communication resources, such as a base station 102 or gNB 180, a monolithic base station or gNB, a portion of a disaggregated base station or gNB, a UE in sidelink communication, etc., can perform the functions described in method 600 shown in FIG. 6 using one or more of the components described in FIGS. 1 and/or 4. Methods 500 and 600 are described in conjunction with one another for ease of explanation; however, the methods 500 and 600 are not required to be performed together and indeed can be performed independently using separate devices.

In method 600, at Block 602, a configuration for a first antenna to receive downlink signaling in a first band can be transmitted. In an aspect, antenna configuring component 452, e.g., in conjunction with processor(s) 412, memory/memories 416, transceiver 402, BS communicating component 442, etc., can transmit (e.g., for or to a UE 104) a configuration for a first antenna (e.g., of the UE 104) to receive downlink signaling (e.g., from the network node) in a first band. For example, the configuration can include a RRC configuration that configures the antennas of the UE 104 for communicating in one or more frequency bands, such to operate at least a first antenna to receive downlink signaling from the network node or transmit uplink signaling to the network node in a first band, and to operate at least a second antenna to receive downlink signaling from the network node or transmit uplink signaling to the network node in a second band. The frequency bands can be, or can include, different CCs. In an example, antenna configuring component 452 can configure each CC for each antenna, and can include slot configurations for each CC, where the slot configuration can indicate, for a given slot or other time period, whether the UE is to transmit uplink communications in the slot (referred to as a “U” slot), receive downlink communications in the slot (referred to as a “D”) slot, or whether the slot is for switching from downlink to uplink (referred to as a “S” slot).

In method 500, at Block 502, a configuration for a first antenna to receive downlink signaling in a first band can be received. In an aspect, UE communicating component 342, e.g., in conjunction with processor(s) 312, memory/memories 316, transceiver 302, etc., can receive (e.g., from a network node) a configuration for a first antenna (e.g., of the UE 104) to receive downlink signaling (e.g., from the network node) in a first band. As described, the configuration can include an RRC configuration that configures the antennas of the UE 104 for communicating in one or more frequency bands, and the UE 104 can receive the configuration and accordingly operate in the one or more frequency bands (e.g., CCs). For example, based on the configuration, UE 104 can operate a first one of antennas 365 to receive signals from the network node or transmit signals to the network node in a first band and can operate a second one of antennas 365 to receive signals from the network node or transmit signals to the network node in a second band.

In method 600, at Block 604, an indication to use the first antenna, during a time period, along with a second antenna to receive downlink signaling in a second band can be transmitted. In an aspect, antenna configuring component 452, e.g., in conjunction with processor(s) 412, memory/memories 416, transceiver 402, BS communicating component 442, etc., can transmit (e.g., for or to a UE 104) an indication to use the first antenna, during the time period, along with the second antenna to receive downlink signaling in the second band. For example, though the first antenna is initially configured for receiving (or transmitting) signaling in the first band, antenna configuring component 452 can cause the UE 104 to recycle the first antenna for additionally receiving (e.g., along with the second antenna) the downlink signaling in the second band. This can enable the UE 104 to achieve diversity gains or other signaling benefits by using multiple antennas. In addition, antenna configuring component 452 can configure the other antenna at the UE 104 during the time period where the first antenna is not being used on the first band (e.g., where the UE 104 is not scheduled for communications in the first band during the time period, such as where the slot direction of the first band is “U” but no uplink transmission is scheduled/configured or when the slot direction of the first band is “D”).

In method 500, at Block 504, an indication to use the first antenna, during a time period, along with a second antenna to receive downlink signaling in a second band can be received. In an aspect, antenna recycling component 352, e.g., in conjunction with processor(s) 312, memory/memories 316, transceiver 302, UE communicating component 342, etc., can receive (e.g., from the network node) the indication to use the first antenna, during the time period, along with the second antenna to receive downlink signaling in the second band. In this regard, antenna recycling component 352 can recycle the first antenna, which is not being used during the time period, for use to receive downlink signaling in the second band along with the second antenna.

For example, antennas can also be similarly recycled for transmitting uplink communications. For recycling an antenna for receiving downlink communications or transmitting uplink communications, antenna configuring component 452 can transmit the indication, and/or antenna recycling component 352 can receive the indication, in semi-static signaling, such as in RRC signaling and/or other signaling, which may have an agreed/configured pattern over time and frequency. In another example, antenna configuring component 452 can transmit the indication, and/or antenna recycling component 352 can receive the indication, in dynamic signaling, such as based on scheduling grants (e.g., in downlink control information (DCI), media access control (MAC)-control element (CE), or other dynamic signaling).

In addition, various mechanisms for transmitting or receiving the indication using dynamic signaling are possible. For example, antenna configuring component 452 can transmit the indication, and/or antenna recycling component 352 can receive the indication, on a per grant basis (e.g., within the grant, such as PDSCH or PUSCH grant, or otherwise), such that antenna switching/sharing can be on a per grant basis. In some examples, “per grant basis” can include where the grant indicates a one-shot antenna switch (e.g., for the duration of the grant). After a time period associated with the resources of the grant passes, antenna recycling component 352 can switch the antennas back to a previous or default state (e.g., antenna recycling component 352 can switch the first antenna back to the first band). In other examples, “per grant basis” can include where the grant indicates the antenna switch (e.g., state-switch) until another grant indicates another antenna switch (e.g., state-switch). In this example, antenna recycling component 352 can maintain the antenna state (e.g., the first antenna assigned to the second band) and does not go back to the previous or default antenna state unless or until it is indicated to do so (e.g., by receiving an associated indication from the base station 102, which may be in a subsequent grant).

In yet another example, antenna switching/sharing among bands can be based on grants as received during an observation period, where the observation period can be configured or defined as a subset of slots. In an example, in method 600, optionally at Block 606, an observation period configuration for an observation period for transmitting antenna switching indications can be transmitted or received. In an aspect, antenna configuring component 452, e.g., in conjunction with processor(s) 412, memory/memories 416, transceiver 402, BS communicating component 442, etc., can transmit or receive the observation period configuration for the observation period for transmitting antenna switching indications. In an example, in method 500, optionally at Block 506, an observation period configuration for an observation period for receiving antenna switching indications can be received or transmitted. In an aspect, antenna recycling component 352, e.g., in conjunction with processor(s) 312, memory/memories 316, transceiver 302, UE communicating component 342, etc., can receive or transmit the observation period configuration for the observation period for receiving antenna switching indications. For example, the observation period configuration can define the observation period to include a subset of slots, such as based on a range of slot indices, an indication of a starting slot and a validity duration of slots, an indication of a period of slots to be part of the observation period and/or another period of slots not to be part of the observation period (or an indication of a total number of slots), etc.

In this example, antenna configuring component 452 can transmit the indication, and/or antenna recycling component 352 can receive the indication in the grant. Based on the grant, antenna recycling component 352 can know the switching/sharing state of the antennas, and can remain in this state for a period of time, which can include the remainder of the validity duration corresponding to the observation period. For example, if the observation period is at a slot where two CCs are both in “D” direction, the grant on the first band (e.g., CC 0) signals the need for six receive antennas and the grant on the second band (e.g., CC 1) signals the need for two receive antennas, then in the other slots within the observation period, antenna recycling component 352 can maintain this state. Any subsequent grants may be considered as valid if they are a subset of what the current state can support, e.g., a grant on CC 0 should not require more than six antennas for DL receptions or UL transmissions, and/or a grant on CC 1 should not require more than two antennas for DL receptions or UL transmissions. In an example, antenna configuring component 452 can ensure compliance of the grants with the current antenna states during the validity duration and/or antenna recycling component 352 can trigger an error (e.g., notify the network node of an error) if a grant received during the validity duration does not comply with the associated antenna switching/sharing states.

In yet another example, antenna recycling component 352 can apply a received switching indication (e.g., a received indication to switch the first antenna to the second band received at Block 504) a given time after feedback is transmitted for a PDSCH reception (e.g., as opposed to applying for the scheduled PDSCH). In yet another example, antenna recycling component 352 can apply the received switching indication based on the feedback (e.g., hybrid automatic repeat/request (HARQ) feedback) having a value of acknowledgement (ACK). For example, antenna recycling component 352 can apply the switching indication (e.g., to switch the first antenna to the second band) at a number, X, symbols after the HARQ feedback (or HARQ-ACK), or the first slot after X symbols after the HARQ feedback (or HARQ-ACK), e.g., quantized to slot boundary. In an example, X can be a fixed value, which may be based on a UE capability indicated by the UE 104 to the network node, or X may be configured to the UE 104 in an RRC configuration, etc.

In an example, a field in the grant (e.g., a field in the DCI, such as a one bit field) can be used to switch between different antenna switching/sharing states (e.g., no switch if the value of the field is unchanged across consecutive DCIs). For example, the one bit field can correspond to two different antenna configurations, such as, for the second band (or a band for which the DCI is received), whether the antenna assigned to the first band is to be used for communications over the second band as well or not. For example, as described, the DCI can be a grant that schedules downlink resources (e.g., a DCI with DL assignment) or a DCI without DL assignment. When the DCI is without DL assignment, UE communicating component 342 can still send HARQ-ACK (but some fields, such as frequency domain resource assignment (FDRA) can have a reserved value). In this example, antenna recycling component 352 can receive the field in the DCI, and can determine whether to apply antenna switching (e.g., using the first antenna assigned to the first band to also communicate in the second band) at the application time, which can be based on the HARQ feedback.

In an example, as a given band or CC may be turned on or off based on the antenna state-switch, and the fact that the antenna state-switch is defined over multiple CCs, the interpretation of the DCI can be also a function of current state (before the antenna switch). For example, if UE 104 is in a baseline state, either a reference CC can be used for monitoring the indication (e.g., at Block 504) in the DCI for the state-switch (e.g., DCI that schedules CC 0), or either of the CCs can be used for monitoring the DCI for the state-switch (DCI that schedules CC 0 or DCI that schedules CC 1). For example, if the UE 104 is in an antenna sharing state in CC 1, CC1 can be used for monitoring the DCI for the state-switch (e.g., DCI that schedules CC 1) assuming that UE does not monitor PDCCH on CC 0 in the current state.

In the above examples, where transmitting the indication at Block 604 or receiving the indication at Block 504 are described in terms of a grant or scheduling DCI, a non-scheduling DCI may alternatively be used to carry the indication. In some cases, the HARQ-ACK feedback can also be used as a consideration of when and/or whether to apply the antenna switching indicated in the scheduling or non-scheduling DCI. Moreover, as described, a UE 104 can be capable of recycling receive antennas, recycling transmit antennas, or recycling both transmit and receive antennas, as described above and further herein.

In method 500, at Block 508, with the antenna switching applied, downlink signaling can be received, during the time period, in the second band using the first antenna and the second antenna. In an aspect, UE communicating component 342, e.g., in conjunction with processor(s) 312, memory/memories 316, transceiver 302, etc., can receive, during the time period, the downlink signaling in the second band using the first antenna and the second antenna. As described above, in some examples, the network node may benefit to have CSI measurements from the UE 104 based on using both of the first antenna and the second antenna to facilitate precoder determination or generation at the network node. For example, when receive antennas can be recycled or borrowed across CCs/bands, as described above, the maximum number of layers can change across slots and/or an available number of receive antennas can change across slots (even for the same number of layers). CSI computation and reporting with varying maximum value for reported ranks can be handled in NR by configuring a UE with different CSI report configuration, but capturing change in number of receive antennas may be enabled using additional configurations or indications described herein. As such, for example, a CSI report from the UE 104, or configuration for CSI reporting, can include a notion of a number of receive antennas used to measure CSI-RSs from the network node.

For example, each report configuration, or resource setting, or resource can include this information. For each CSI report configuration, the number of rank can be indicated for report (e.g., rank restriction), which may be sufficient for indicating the number of antennas to use to receive the CSI-RSs from the network node. If the maximum rank for report is configured per CSI resource, e.g., for network energy savings (NES), however, the number of receive antennas can be separately associated with each CSI resource. If the UE 104 is configured with a number of receive antennas for a CSI reporting, the UE can use the same/consistent set of receive antennas for the CSI reporting. For example, suppose a UE having up to eight receive antennas on a CC may be configured to switch between a state with four receive antennas and another state with eight receive antennas. If the UE is configured with CSI reporting with four receive antennas, the UE can use the same four receive antennas for CSI measurement. The measurement over multiple measurement occasions for the CSI reporting may not be from different sets of antennas for different slots. This can ensure the CSI reporting relates to the same sets of antennas, which can allow the network node to generate the precoder without necessarily knowing which antennas the UE 104 is using.

In method 600, optionally at Block 608, a reference signal configuration indicating a number of antennas to use for performing reference signal measurements can be transmitted. In an aspect, CSI configuring component 454, e.g., in conjunction with processor(s) 412, memory/memories 416, transceiver 402, BS communicating component 442, etc., can transmit (e.g., for or to a UE 104) the reference signal configuration indicating the number of antennas to use for performing reference signal measurements. For example, CSI configuring component 454 can transmit the configuration as a CSI report configuration, a CSI resource setting, or a CSI resource including the number of associated antennas, as described above and further herein.

In method 500, optionally at Block 510, a reference signal configuration indicating a number of antennas to use for performing reference signal measurements can be received. In an aspect, CSI configuration processing component 354, e.g., in conjunction with processor(s) 312, memory/memories 316, transceiver 302, UE communicating component 342, etc., can receive (e.g., from the network node) the reference signal configuration indicating the number of antennas to use for performing reference signal measurements. For example, the reference signal configuration can be, or can indicate the number of antennas per, CSI report configuration, CSI resource setting, or CSI resource.

In method 500, optionally at Block 512, reference signal measurements of one or more reference signals in the second band can be performed based on the indication or reference signal configuration. In an aspect, CSI generating component 356, e.g., in conjunction with processor(s) 312, memory/memories 316, transceiver 302, UE communicating component 342, etc., can perform reference signal measurements of the one or more reference signals in the second band based on the indication or reference signal configuration. For example, CSI generating component 356 can perform the reference signal measurements using the indicated antenna configuration (e.g., using the first and second antenna). In an example, CSI generating component 356 can determine the antenna configuration to use in measuring the reference signals based on the number of antennas indicated in the reference signal configuration (and/or can use the same antenna configuration for each number of antennas that can be indicated so the CSI is consistent for the number of antennas).

In method 500, optionally at Block 514, reference signal measurements performed using the number of antennas can be transmitted. In an aspect, UE communicating component 342, e.g., in conjunction with processor(s) 312, memory/memories 316, transceiver 302, etc., can transmit (e.g., to the network node) the reference signal measurements performed using the number of antennas. For example, UE communicating component 342 can transmit the reference signal measurements in resources assigned for CSI reporting. In an example, CSI generating component 356 can generate the CSI report to indicate the receive antennas used to measure the CSI-RSs being reported.

In method 600, optionally at Block 610, reference signal measurements performed using the number of antennas can be received. In an aspect, BS communicating component 442, e.g., in conjunction with processor(s) 412, memory/memories 416, transceiver 402, etc., can receive (e.g., from the UE 104) the reference signal measurements performed using the number of antennas. For example, BS communicating component 442 can receive the reference signal measurements in resources assigned for CSI reporting (e.g., in the CSI report configuration).

In method 600, optionally at Block 612, downlink signaling can be transmitted in the second band based on a precoder associated with the UE using the first antenna and the second antenna. In an aspect, precoding component 456, e.g., in conjunction with processor(s) 412, memory/memories 416, transceiver 402, BS communicating component 442, etc., can transmit downlink signaling in the second band based on the precoder associated with the UE using the first antenna and the second antenna. For example, precoding component 456 can generate the precoder based on the reference signal measurements received from the UE 104, where the UE 104 used the same antenna configuration or number of antennas for the reference signal measurements as it is assigned to use to receive the downlink signaling. This can ensure the precoder is optimized for the antenna configuration used by the UE 104 to receive the downlink signaling when antenna recycling, borrowing, switching, etc., is enabled, as described herein.

Aligning, for the network node and the UE, the number and/or configuration of receive antennas used by the UE can help to align the DL link adaptation, CSI reports, and grants. Various approaches can be used to achieve this objective. In one example, where the antenna switching/sharing is dynamic and can change with each grant, the network node can include or indicate the expected number of receive antennas for reception in the grant. In another example, the network node can indicate the expected number of receive antennas at the beginning of each validity period over an observation period, as described above.

For example, in transmitting the indication at Block 604, optionally at Block 614, a downlink grant that includes the indication and/or a second indication of the number of antennas to use for measuring CSI-RSs for reporting CSI for the second band or receiving downlink signaling can be transmitted. In an aspect, CSI configuring component 454, e.g., in conjunction with processor(s) 412, memory/memories 416, transceiver 402, BS communicating component 442, etc., can transmit the downlink grant (e.g., to the UE 104 in DCI) that includes the indication and/or a second indication of a number of antennas to use for measuring CSI-RSs for reporting CSI for the second band or receiving downlink signaling.

For example, in receiving the indication at Block 504, optionally at Block 516, a downlink grant that includes the indication and/or a second indication of the number of antennas to use for measuring CSI-RSs for reporting CSI for the second band or receiving downlink signaling can be received. In an aspect, CSI configuration processing component 354, e.g., in conjunction with processor(s) 312, memory/memories 316, transceiver 302, UE communicating component 342, etc., can receive and/or process the downlink grant (e.g., from the network node in DCI) that includes the indication and/or a second indication of a number of antennas to use for measuring CSI-RSs for reporting CSI for the second band or receiving downlink signaling. In an example, CSI generating component 356 can accordingly use the number of antennas (e.g., a configuration of antennas that includes the number of antennas) in measuring CSI-RSs received from the network node, as described above. In another example, UE communicating component 342 can accordingly use the number of antennas (e.g., a configuration of antennas that includes the number of antennas) in receiving downlink signaling from the network node, as described above.

In an example, UE communicating component 342 can be allowed a switching gap after receiving the PDCCH carrying the DCI indicating the antenna switch, during which the UE 104 can perform receive and/or transmit antenna switching. This can be a non-zero K0, where K0 is a gap between the end of PDCCH and start of PDSCH. In an example, UE communicating component 342 can report a supported or required gap size to the network node in UE capability signaling (e.g., in RRC signaling from the UE 104 to the network node). In an example, where the antenna switching information is received at the beginning of a validity period, less switching gap overhead may be present as compared to where the antenna switching information is received in DCI not within a validity duration of an observation period.

In yet another example, for configured channels in DL and/or UL, e.g., semi-persistent scheduling (SPS) and/or configured grant (CG), the number of receive and/or transmit antennas may be included as part of the RRC configuration of SPS and/or CG resources. In this example, antenna configuring component 452 can transmit the indication, and/or antenna recycling component 352 can receive the indication, in the RRC signaling that configures SPS or CG resources.

In another example, where antenna configuring component 452 can transmit the indication, and/or antenna recycling component 352 can receive the indication in RRC signaling or other semi-static signaling, some slots antenna configuration across CCs of bands can be based on a first pattern and in other slots based on a second pattern. In this example, CSI report configurations may use a similar approach. For example, in the DL slots where antenna recycling of a first pattern is configured, CSI generating component 356 can measure CSI-RSs with a same assumption for the number of receive antennas. As PDSCH scheduling can also follow a time pattern like mentioned above, the network node can map the CSI reports to corresponding slots without ambiguity. For example, the number of receive antennas for CSI measurement and report can be dependent on a time pattern, e.g., slot indices (such that it may not be explicitly tied to a CSI report configuration, CSI resource setting, or CSI resource). This time pattern can be mapped to the receive antenna recycling pattern as mentioned above. The time pattern may be configured for a UE, e.g., via RRC signaling. In an example, the pattern may be indicated to the UE for the purpose of CSI measurement with aligned assumption with the network node and also for taking average CSI over different slots (e.g., as is the case for P-CSI where a UE could perform averaging preparing the report).

In these examples, in method 600, optionally at Block 616, an indication of a time pattern can be transmitted in RRC signaling configuring resources for the downlink signaling. In an aspect, CSI configuring component 454, e.g., in conjunction with processor(s) 412, memory/memories 416, transceiver 402, BS communicating component 442, etc., can transmit the indication of the time pattern in RRC signaling configuring resources for the downlink signaling. Moreover, in these examples, in method 500, optionally at Block 518, an indication of a time pattern can be received in RRC signaling configuring resources for the downlink signaling. In an aspect, CSI configuration processing component 354, e.g., in conjunction with processor(s) 312, memory/memories 316, transceiver 302, UE communicating component 342, etc., can receive the indication of the time pattern in RRC signaling configuring resources for the downlink signaling.

In the above examples, in method 500, optionally at Block 520, a number of antennas used for measuring CSI-RS for reporting CSI for the second band can be determined, based on the time pattern, to include at least the first antenna and the second antenna. In an aspect, CSI generating component 356, e.g., in conjunction with processor(s) 312, memory/memories 316, transceiver 302, UE communicating component 342, etc., can determine, based on the time pattern, the number of antennas used for measuring CSI-RS for reporting CSI for the second band to include at least the first antenna and the second antenna. CSI generating component 356 can accordingly measure CSI-RSs received from the network node during the time period based on the time pattern and the number of antennas associated with (e.g., configured for) the time pattern.

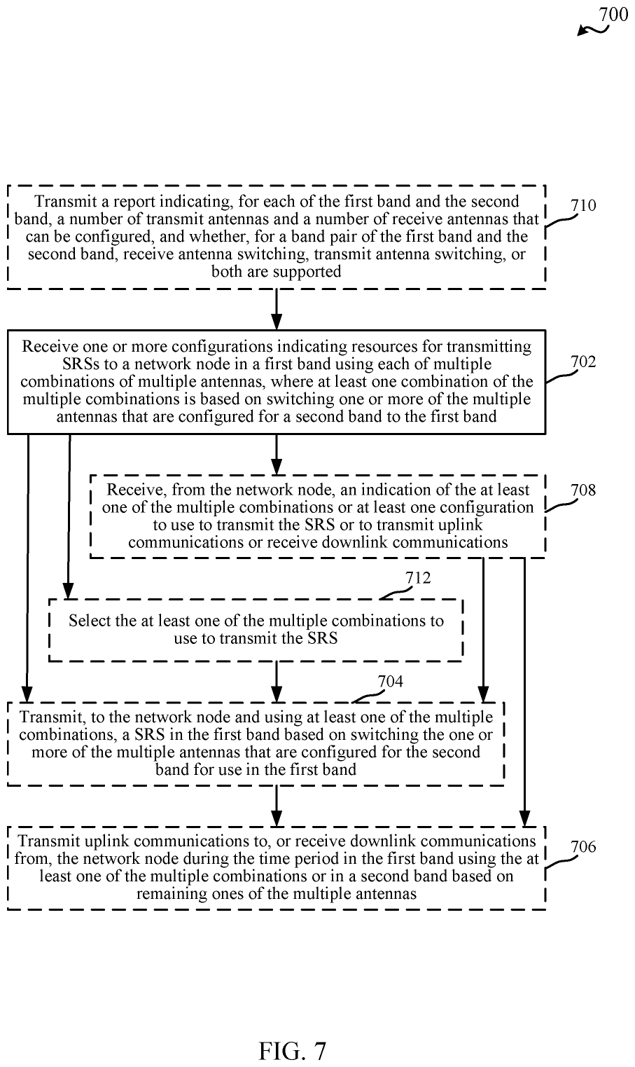

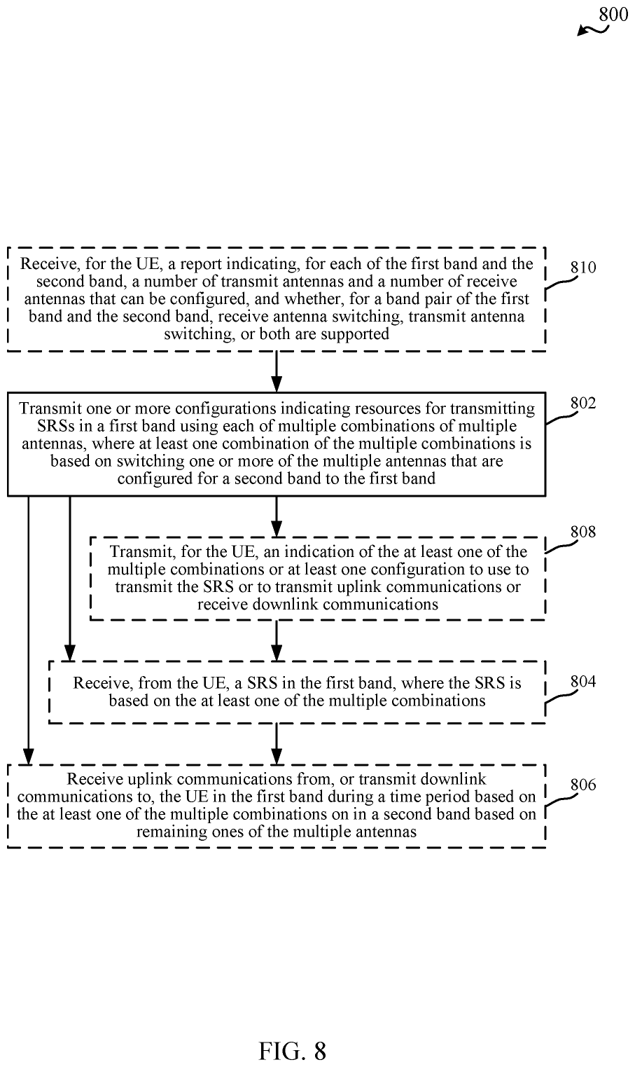

FIG. 7 illustrates a flow chart of an example of a method 700 for recycling antennas in multi-CC operations including SRS transmission, in accordance with aspects described herein. FIG. 8 illustrates a flow chart of an example of a method 800 for configuring a UE recycling antennas in multi-CC operations including SRS transmission, in accordance with aspects described herein. In an example, a UE 104 can perform the functions described in method 700 shown in FIG. 7 using one or more of the components described in FIGS. 1 and/or 3. In an example, a node scheduling the UE 104 with communication resources, such as a base station 102 or gNB 180, a monolithic base station or gNB, a portion of a disaggregated base station or gNB, a UE in sidelink communication, etc., can perform the functions described in method 800 shown in FIG. 8 using one or more of the components described in FIGS. 1 and/or 4. Methods 700 and 800 are described in conjunction with one another for ease of explanation; however, the methods 700 and 800 are not required to be performed together and indeed can be performed independently using separate devices.

In method 800, at Block 802, one or more configurations indicating resources for transmitting SRSs in a first band using each of multiple combinations of multiple antennas can be transmitted, where at least one combination of the multiple combinations is based on switching one or more of the multiple antennas that are configured for a second band to the first band. In an aspect, antenna configuring component 452, e.g., in conjunction with processor(s) 412, memory/memories 416, transceiver 402, BS communicating component 442, etc., can transmit (e.g., for or to a UE 104) the one or more configurations indicating resources for transmitting SRSs in the first band using each of multiple combinations of multiple antennas, where at least one combination of the multiple combinations is based on switching one or more of the multiple antennas that are configured for a second band to the first band. For example, the one or more configurations can include SRS configurations indicating one or more combinations of multiple antennas over which to transmit SRS, which can allow the network node to receive the SRS and determine a SRS resource indication (SRI) to use in receiving uplink communications from the UE 104, or determine a precoder to use in transmitting downlink communications to the UE 104. In an example, the one or more configurations may include a single configuration that indicates the multiple combinations of antennas the UE 104 can use to transmit SRS, or the one or more configurations can include one configuration for each combination of antennas the UE 104 can use to transmit SRS, etc. For example, antenna configuring component 452 can transmit the one or more configurations to the UE 104 in RRC or other semi-static signaling.

In method 700, at Block 702, one or more configurations indicating resources for transmitting SRSs to a network node in a first band using each of multiple combinations of multiple antennas can be received, where at least one combination of the multiple combinations is based on switching one or more of the multiple antennas that are configured for a second band to the first band. In an aspect, UE communicating component 342, e.g., in conjunction with processor(s) 312, memory/memories 316, transceiver 302, etc., can receive (e.g., from the network entity) the one or more configurations indicating resources for transmitting SRSs to the network node in the first band, where at least one combination of the multiple combinations is based on switching one or more of the multiple antennas that are configured for a second band to the first band. For example, the one or more configurations can include a SRS configurations indicating one or more combinations of multiple antennas over which to transmit SRS to the network node. As described, for example, the one or more configurations may include a single configuration that indicates the multiple combinations of antennas the UE 104 can use to transmit SRS, or the one or more configurations can include one configuration for each combination of antennas the UE 104 can use to transmit SRS, etc. For example, UE communicating component 342 can receive the SRS configuration from the network node in RRC or other semi-static signaling.

In method 700, optionally at Block 704, a SRS can be transmitted to the network node, using at least one of the multiple combinations, in the first band based on switching the one or more of the multiple antennas that are configured for the second band for use in the first band. In an aspect, UE communicating component 342, e.g., in conjunction with processor(s) 312, memory/memories 316, transceiver 302, etc., can transmit, to the network node and using at least one of the multiple combinations of the multiple antennas, the SRS in the first band based on switching the one or more of the multiple antennas that are configured for the second band for use in the first band. For example, based on the at least one of the multiple combinations indicated in the one or more configurations, at least one of the multiple antennas, which may correspond to a SRS port, SRS resource set, or SRS set in an SRS configuration for the second band, can be recycled for use in the first band, based on the one or more configurations, for transmitting SRS in the first band. For example, an SRS port can be associated with an individual antennas and/or the various combinations of antennas that are indicated in the configuration, which may include the antennas configured for the first band and/or second band (e.g., where antenna sharing is supported across CCs). In one example, UE communicating component 342 can indicate, to the network node, a number of antennas or which antennas are configured for the second band, and the one or more configurations can be generated based at least in part on this information. In another example, as described further herein, the network node can indicate to the UE 104 the number of antennas and/or which antennas to use to transmit the SRS in the first band.

In method 700, optionally at Block 706, uplink communications can be transmitted to, or downlink communications can be received from, the network node during a time period in the first band using the at least one of the multiple combinations or in a second band based on remaining ones of the multiple antennas. In an aspect, UE communicating component 342, e.g., in conjunction with processor(s) 312, memory/memories 316, transceiver 302, etc., can transmit uplink communications to, or receive downlink communications from, the network node during the time period in the first band using the at least one of the multiple combinations of the multiple antennas or in the second band based on remaining ones of the multiple antennas. In this example, as described further herein, the antennas recycled to the first band and/or the antennas remained on the second band may be indicated to the network node so the network node can generate an appropriate precoder for a downlink transmission or select an appropriate SRI for receiving an uplink transmission in the associated band. In one example, UE communicating component 342 can indicate, to the network node, a number of antennas or which antennas are used to transmit uplink communications and/or receive downlink communications during the time period in the first band (or the second band). In another example, as described further herein, the network node can indicate to the UE 104 the number of antennas and/or which antennas to use to transmit uplink communications and/or receive downlink communications during the time period in the first band (or the second band).

In method 800, optionally at Block 804, a SRS can be received from the UE in the first band, where the SRS is based on the at least one of the multiple combinations. In an aspect, BS communicating component 442, e.g., in conjunction with processor(s) 412, memory/memories 416, transceiver 402, etc., can receive, from the UE, the SRS in the first band, where the SRS is based on the at least one of the multiple combinations of the multiple antennas. For example, the UE can recycle at least one of the multiple antennas, which corresponds to a SRS port, SRS resource set, or SRS set in the SRS configuration for the second band, for use in the first band, based on the one or more configurations, for transmitting SRS in the first band.

In method 800, optionally at Block 806, uplink communications can be received from, or downlink communications can be transmitted to, the UE during a time period in the first band based on the at least one of the multiple combinations or in the second band based on remaining ones of the multiple antennas. In an aspect, BS communicating component 442, e.g., in conjunction with processor(s) 412, memory/memories 416, transceiver 402, etc., can receive uplink communications from, or transmit downlink communications to, the UE during the time period in the first band based on the at least one of the multiple combinations of the multiple antennas or in the second band based on remaining ones of the multiple antennas. For example, the UE can remain the at least another one of the multiple antennas, which corresponds to a SRS port, SRS resource set, or SRS set in the SRS configuration, on the second band. In this example, as described further herein, the antennas recycled to the first band and/or the antennas remained on the second band may be known by the network node based on an indication configuration to use to transmit the SRS, or may be indicated to the network node by the UE 104, so the network node can generate an appropriate precoder or SRI for communications transmitted or received over the first band and/or second band. In an example, receiving the uplink communications from, or transmitting the downlink communications to, the UE can include generating a precoder or SRI based on the SRS ports, SRS resource sets, or SRS sets associated with the at least another one of the multiple antennas remaining on the second band.

Indicating the possible combinations of antennas that can be used on a given band can help ensure that the UE 104 transmits using one of the combinations of antennas for which the UE 104 transmits SRS. This can allow the network node to select an appropriate SRI for receiving uplink communications from the UE 104 that uses the combination of antennas to transmit the uplink communications or select an appropriate precoder for transmitting downlink communications to the UE 104 that uses the combination of antennas to receive the downlink communications. For example, transmit and/or receive antenna recycling by the UE (e.g., by antenna recycling component 352) can follow a pattern such that the network node knows which SRS ports are remained on the same CC and can be used for PDSCH transmission. This can be true for various usage indications for the SRS resource set, including “usage=antenna switching,” “usage=NCB,” “usage=CB,” etc., as indicated in the configuration.

For example, when recycling UL antennas of one CC for downlink reception or uplink transmission on another CC, and in case of SRS resource set configuration with usage set to antenna switching or NCB or CB, the SRS ports remained on a CC may be known or indicated to the network. In this example, UL antenna recycling can be tied to SRS ports or SRS resources or SRS sets (e.g., as indicated in the configuration). In one example, antenna recycling component 352 can recycle antennas from the first band to the second band, and/or vice versa, based on one or more defined rules. The rules can be semi-static, in one example, such as a rule that for a UE supporting four-port SRS, port 1 and 2 are to remain on a source CC and port 3 and 4 can be borrowed by target CC. In another example, the rules or associated indications can be in DCI or based on semi-static pattern. Alternatively, or additionally, antenna recycling component 352 of a UE 104 can indicate (e.g., in UE capability in RRC signaling, uplink control information (UCI), or otherwise) its preference on antennas associated to which SRS to keep and which ones to share with other CCs. In addition, for example, the network node may similarly need to know which ports may be available for UL transmission when PUSCH is scheduled.

Thus, in one example, in method 800, optionally at Block 808, an indication of the at least one of the multiple combinations or at least one configuration to use to transmit the SRS, or to transmit uplink communications or receive downlink communications, can be transmitted to the UE. In an aspect, antenna configuring component 452, e.g., in conjunction with processor(s) 412, memory/memories 416, transceiver 402, BS communicating component 442, etc., can transmit, to the UE, an indication of the at least one of the multiple combinations or at least one configuration to use to transmit the SRS. As described, for example, where the one or more configurations include a single configuration indicating the multiple combinations of antennas, the indication can indicate at least one of the multiple combinations to use to transmit the SRS or to transmit uplink communications or receive downlink communications. In another example, where the one or more configurations include a configuration for each combination, the indication can indicate the configuration to use to transmit the SRS (and/or subsequently transmit uplink communications or receive downlink communications). For example, antenna configuring component 452 can transmit the indication in DCI signaling to the UE 104, or in other dynamic signaling (e.g., MAC-CE), to indicate which of the multiple combinations or configurations to use to transmit the SRS. In an example, antenna configuring component 452 can transmit the indication with an indicated purpose for the SRS, such as NCB-PUSCH, SRS for antenna switching, etc., and antenna configuring component 452 can determine which of the multiple combinations the UE 104 is expected to use to transmit SRS, or to transmit uplink communications or receive downlink communications, based on the indicated purpose.

In an example, in method 700, optionally at Block 708, an indication of the at least one of the multiple combinations or at least one configuration to use to transmit the SRS, or to transmit uplink communications or receive downlink communications, can be received from the network node. In an aspect, antenna recycling component 352, e.g., in conjunction with processor(s) 312, memory/memories 316, transceiver 302, UE communicating component 342, etc., can receive, from the network node, the indication of the at least one of the multiple combinations or at least one configuration to use to transmit the SRS or to transmit uplink communications or receive downlink communications. In an example, antenna recycling component 352 can accordingly recycle the at least one of the multiple antennas from the second band to the first band, based on the indicated combination or configuration, for transmitting the SRS, as described herein. In an example, the indication can include an indicated purpose for the SRS, such as NCB-PUSCH, SRS for antenna switching, etc., and antenna recycling component 352 can determine, based on the indicated purpose, which of the multiple combinations to use in transmitting the SRS or to transmit uplink communications or receive downlink communications.

In another example, in method 700, optionally at Block 712, at least one of the multiple combinations to use to transmit the SRS can be selected. In an aspect, antenna recycling component 352, e.g., in conjunction with processor(s) 312, memory/memories 316, transceiver 302, UE communicating component 342, etc., can select the at least one of the multiple combinations to use to transmit the SRS. For example, antenna recycling component 352 can select the at least one of the multiple combinations based on a rule (e.g., defined in the wireless communication technology specification, such as 5G NR), as described in further detail herein.

As described above, a UE can be configured with a SRS resource set having, per band, a number of resources to allow for transmitting SRSs based on a number of transmit antennas and a number of receive antennas (e.g., xTyR). For example, for a UE that supports 1T2R in band B1 and 1T2R in band B2, the UE can be configured with a SRS resource set having, for each band, two resources—one per port—in TDM. For a UE 104 that supports antenna recycling, however, the UE 104 can be configured with additional resources for each possible combination of antennas when antenna recycling is used to enable antenna switching a corresponding precoder generation based on antennas being used.

For example, the UE 104 may support transmit antenna sharing, receive antenna sharing or both across B1 and B2. If it supports receive antenna sharing such that it can use 1T4R, SRS resources for 1T4R can be configured. If it supports transmit antenna sharing such that it can use 2T2R, SRS resources for 2T2R can be configured. If it supports both transmit and receive antenna sharing such that it can use 2T4R, SRS resources for 2T4R can be configured. In an example, the configuration transmitted by SRS configuring component 458 (e.g., at Block 802) and/or received by UE communicating component 342 (e.g., at Block 702) may include SRS resources, per band for one or more bands, for each combination of antennas supported by the UE 104 (e.g., using antenna sharing or otherwise).

In one example, the UE 104 can transmit UE capability information (e.g., in RRC signaling) to the network node, that can indicate bands over which antenna recycling is supported, possible combinations or numbers of antennas for such bands when antenna recycling is supported, etc. In an example, for a given band combination, e.g., B1-B2, UE 104 can separately report xTyR for each band. For these pair of bands, the UE 104 can indicate whether it supports receive antenna switching, transmit antenna switching, or both, and/or which x′Ty′R combination it supports (e.g., the capability signaling can be on a per pair of bands in a band combination, as described above). If there are more than two bands where the UE can do transmit and/or receive antenna switching, then the report may be per pair of bands, per triple of bands and so on per band combination.

In an example, in method 700, optionally at Block 710, a report indicating, for each of the first band and the second band, a number of transmit antennas and a number of receive antennas that can be configured, and whether, for a band pair of the first band and the second band, receive antenna switching, transmit antenna switching, or both are supported, can be transmitted. In an aspect, antenna recycling component 352, e.g., in conjunction with processor(s) 312, memory/memories 316, transceiver 302, UE communicating component 342, etc., can transmit (e.g., to the network node) the report indicating, for each of the first band and the second band, a number of transmit antennas and a number of receive antennas that can be configured, and whether, for a band pair of the first band and the second band, receive antenna switching, transmit antenna switching, or both are supported. For example, antenna recycling component 352 can transmit the report in UE capability information, as described above, to enable the network node to determine an SRS resource set having SRS resources for various possible combinations of antennas in one or more bands.

In an example, in method 800, optionally at Block 810, a report indicating, for each of the first band and the second band, a number of transmit antennas and a number of receive antennas that can be configured, and whether, for a band pair of the first band and the second band, receive antenna switching, transmit antenna switching, or both are supported, can be received. In an aspect, SRS configuring component 458, e.g., in conjunction with processor(s) 412, memory/memories 416, transceiver 402, BS communicating component 442, etc., can receive (e.g., for the UE 104) the report indicating, for each of the first band and the second band, a number of transmit antennas and a number of receive antennas that can be configured, and whether, for a band pair of the first band and the second band, receive antenna switching, transmit antenna switching, or both are supported. For example, SRS configuring component 458 can receive the report in UE capability information, as described above, and can use the UE capability information to generate the configuration for transmitting SRS (e.g., as transmitting at Block 802 and/or received at Block 704).

In an example, the UE 104 can be configured with multiple SRS configurations, one per xTyR that it can support, on a given CC at different slots. In this example, transmitting the configuration at Block 802, and/or receiving the configuration at Block 704, can include the SRS configuring component 458 transmitting, and/or the UE communicating component 342 receiving, multiple SRS configurations. In some cases, these SRS configurations may be separate and independent of each other, or may be combined in a single configuration. In an example, there may be one configuration that covers different xTyR cases, and the UE can transmit SRS based on the one configuration. In an example, the UE may use a subset of configuration in transmitting SRS depending on its xTyR configured at that slot. For example, if the UE 104 can support 1T2R as a baseline and can support 2T4R when transmit and/or receive antennas are recycled, the UE 104 can be configured with resources for transmitting SRS for 2T4R, but may only use the subset of resources and/or SRS ports (e.g., use port 0 from first SRS resource and port 2 of the second SRS resource) when some antennas are used by the other CC/band. In one example, the selection of port and/or corresponding resources may be specified or otherwise indicated (e.g., dynamically or semi-statically) between the UE and the network node (e.g., in UCI signaling from the UE 104 to the network node, in DCI signaling from the network node to the UE 104, etc.).

In another example, the selection of ports and/or resources can be specified based on a rule (e.g., defined in the wireless communication technology specification, such as 5G NR). An example of a rule may include, where the UE uses 1T2R baseline and 2T4R with both receive and transmit antenna borrowing, when switching to baseline, the antenna recycling component 352 can use receive and/or transmit antennas associated with the first half of SRS ports from each SRS resource for transmitting SRS (e.g., port 0 from first SRS resource and port 0 from second SRS resource). Another example of a rule may include, where the UE uses 1T2R baseline and 1T4R with only receive antenna borrowing, when switching to baseline, the antenna recycling component 352 can use receive antennas associated with SRS ports of the first half of SRS resources for transmitting SRS (e.g., out of four SRS resources, use the two SRS resources with lower IDs; or if these four SRS resources belong to two SRS resource sets, use the SRS resource set with lower ID). In such examples, where the UE 104 downgrades the resources (e.g., uses a subset of those configured), UE communicating component 342 can keep the power per port as the root configuration or may adapt based on the actual transmission. For example, if the UE 104 is configured with 2T4R, and transmitting SRS based on 2T4R, UE communicating component 342 can split power across two ports in each symbol. When using the same configuration for 1T2R, the power could be based on split power or power per port is boosted by 3 decibels (e.g., because there is only one port sounded per symbol). In an example, the power splitting behavior can be configured to the UE 104 based on a configuration transmitted by the network node to the UE 104.

In other examples, in addition to PDSCH/PUSCH traffic, the UE 104 may perform L1/L3 measurements for serving/neighbor cell based on multiple receive antennas. Aspects described herein can similarly be used for such measurements. For example, for RSRP measurements on the serving cell, the UE 104 and network node may have aligned understanding of the number of receive antennas used for the purpose of measurements (e.g., based on the network node assigning the number of receive antennas in one or more indications, such as the indication transmitted in Block 604 or the DCI transmitted in Block 808, the UE indicating the number of receive antennas, etc.). Additionally, in some examples, the network node may specify the thresholds of radio link monitoring (RLM), beam failure recovery (BFR), radio resource measurement (RRM), etc. based on a fixed set of (primary) receive antennas, which may be indicated in a configuration, such as RRC configuration or other semi-static configuration. Alternatively, UE communicating component 342 may average the RSRP measurements across the “activated” receive antennas, where the number of activated receive antennas can change with antenna switching (e.g., based on the indication received from the network node at Block 504 or as otherwise determined by the UE for transmitting uplink communications or receiving downlink communications, as described herein). For example, for measurements of the neighbor cell(s), the neighbor cell may indicate whether antenna sharing is supported (e.g., in system information (SI). In this example, UE communicating component 342 may receive and decode the SI to determine whether antenna sharing is supported, and may accordingly measure the L1/L3 signals using an associated set of receive antennas. In other words, for example, the indication from the network node may be used to determine the set of “activated” receive antennas applicable to L1/L3 measurements.

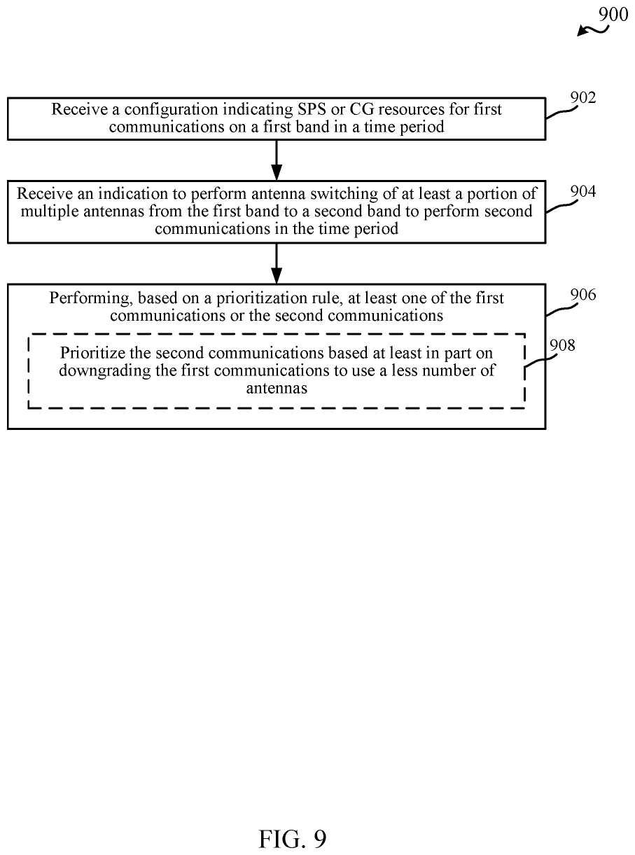

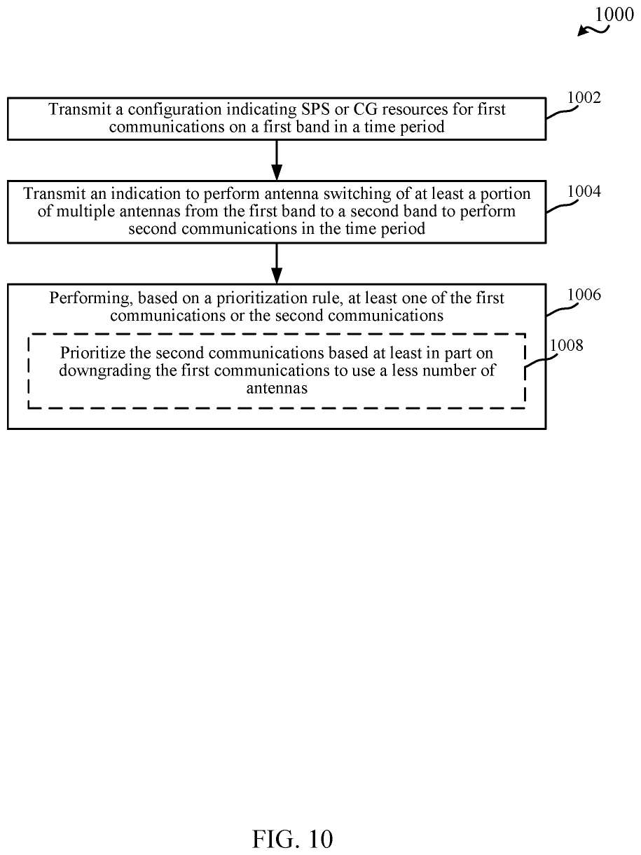

FIG. 9 illustrates a flow chart of an example of a method 900 for a UE prioritizing communications where different numbers of antennas are configured, in accordance with aspects described herein. FIG. 10 illustrates a flow chart of an example of a method 1000 for a network node prioritizing communications where different numbers of antennas are configured, in accordance with aspects described herein. In an example, a UE 104 can perform the functions described in method 900 shown in FIG. 9 using one or more of the components described in FIGS. 1 and/or 3. In an example, a node scheduling the UE 104 with communication resources, such as a base station 102 or gNB 180, a monolithic base station or gNB, a portion of a disaggregated base station or gNB, a UE in sidelink communication, etc., can perform the functions described in method 1000 shown in FIG. 10 using one or more of the components described in FIGS. 1 and/or 4. Methods 900 and 1000 are described in conjunction with one another for ease of explanation; however, the methods 900 and 1000 are not required to be performed together and indeed can be performed independently using separate devices.

In method 1000, at Block 1002, a configuration indicating SPS or CG resources for first communications on a first band in a time period can be transmitted. In an aspect, BS communicating component 442, e.g., in conjunction with processor(s) 412, memory/memories 416, transceiver 402, etc., can transmit the configuration indicating the SPS or CG resources for the first communications on the first band in the time period. For example, BS communicating component 442 can transmit the configuration as a SPS configuration or grant configuring parameters indicating SPS resources (in frequency and/or time) for the UE 104 to use in receiving downlink communications from the network node (e.g., PDCCH or PDSCH). In another example, BS communicating component 442 can transmit the configuration as a CG configuration or grant configuring parameters indicating CG resources (in frequency and/or time) for the UE 104 to use in transmitting uplink communications to the network node (e.g., PUCCH or PUSCH). In an example, BS communicating component 442 can transmit the configuration in semi-static (e.g., RRC) signaling, and can later activate one or more of the configured SPS or CG resources using dynamic signaling grants (e.g., DCI). In an example, antenna configuring component 452 can also configure, for the UE 104, at least a portion of multiple antennas to be used for communicating using the SPS or CG resources (e.g., as indicated in the configuration at Block 1002 or otherwise received in the activation DCI).

In method 900, at Block 902, a configuration indicating SPS or CG resources for first communications on a first band in a time period can be received. In an aspect, UE communicating component 342, e.g., in conjunction with processor(s) 312, memory/memories 316, transceiver 302, etc., can receive the configuration indicating the SPS or CG resources for the first communications on the first band in the time period. For example, UE communicating component 342 can receive the configuration as a SPS configuration or grant configuring parameters indicating SPS resources (in frequency and/or time) for the UE 104 to use in receiving downlink communications from the network node (e.g., PDCCH or PDSCH). In another example, UE communicating component 342 can receive the configuration as a CG configuration or grant configuring parameters indicating CG resources (in frequency and/or time) for the UE 104 to use in transmitting uplink communications to the network node (e.g., PUCCH or PUSCH). In an example, UE communicating component 342 can receive the configuration in semi-static (e.g., RRC) signaling, and can later receive an activation command for one or more of the configured SPS or CG resources in a dynamic signaling grant (e.g., DCI).

In method 1000, at Block 1004, an indication to perform antenna switching of at least a portion of multiple antennas from the first band to a second band to perform second communications in the time period can be transmitted. In an aspect, antenna configuring component 452, e.g., in conjunction with processor(s) 412, memory/memories 416, transceiver 402, BS communicating component 442, etc., can transmit the indication to perform antenna switching of at least a portion of multiple antennas from the first band to a second band to perform second communications in the time period. For example, antenna configuring component 452 can transmit the indication in dynamic signaling, such as in DCI as described above, to perform antenna switching for various purposes described herein.

In method 900, at Block 904, an indication to perform antenna switching of at least a portion of multiple antennas from the first band to a second band to perform second communications in the time period can be received. In an aspect, antenna recycling component 352, e.g., in conjunction with processor(s) 312, memory/memories 316, transceiver 302, UE communicating component 342, etc., can receive the indication to perform antenna switching of at least a portion of multiple antennas from the first band to a second band to perform second communications in the time period. For example, antenna recycling component 352 can receive the indication in dynamic signaling, such as in DCI as described above, to perform antenna switching for various purposes described herein. As the SPS or CG resources are already previously configured for the time period, however, this may cause conflict where one or more of the antennas configured for the first communications over SPS or CG resources are now being switched to the second band for second communications in the same time period.

In some examples, it may be possible that there is a conflict between the expected number of transmit or receive antennas to be used by the UE 104. For example, UE communicating component 342 may receive a CG-PUSCH configuring four transmit antennas for a two-port transmission on CC 0, and a dynamic grant indicating the UE to use six receive antennas for receiving downlink communications on CC 1, but the UE 104 may have only eight antennas. A UE only has 8 antennas as an example. In one example, the UE may not be expected to be in such scheduling scenarios. In an example, antenna recycling component 352 can consider this scenario as an error event (e.g., can consider receiving the indication at Block 904 as an error event). In this regard, for example, antenna recycling component 352 may ignore the indication and/or may output a notification of the error (e.g., to a log file in memory/memories 316, in a communication to the network node, etc.).

In method 900, at Block 906, at least one of the first communications or the second communications can be performed based on a prioritization rule. In an aspect, UE communicating component 342, e.g., in conjunction with processor(s) 312, memory/memories 316, transceiver 302, etc., can perform, based on a prioritization rule, at least one of the first communications or the second communications. For example, UE communicating component 342 can employ the prioritization rule when the antenna switching conflicts with the first communications over the SPS or CG resources. For example, the prioritization rule may indicate to drop or prioritize one or more channels. For instance, where the indication received at Block 904 is a DCI indicating resources over which to perform (e.g., transmit or receive) the second communications using antennas borrowed from the first band, the prioritization rule may specify to prioritize dynamic grants (e.g., the DCI indication for the second communications) over SPS or CG grants (e.g., over the first communications), and as such in this example, antenna recycling component 352 can recycle the antennas from the first band to the second band and perform the second communications. In another example, the prioritization rule may indicate to prioritize a certain type of channel (e.g., PDCCH over PUSCH), prioritize a certain cell index (e.g., for cells related to the first band or the second band), etc. In any case, for example, where the UE communicating component 342 is to prioritize a communication based on a prioritization rule, UE communicating component 342 can perform the prioritized communication and cancel the non-prioritized communication in the time period.

For example, in determining which antennas to use over the corresponding band(s), antenna recycling component 352 may use the prioritization rule(s), which can result in antenna recycling component 352 considering some channels as dropped. In the example where UE communicating component 342 may receive a CG-PUSCH configuring four transmit antennas for a two-port transmission on CC 0, and a dynamic grant indicating the UE to use six receive antennas for receiving downlink communications on CC 1, prioritization rules can indicate to prefer dynamic grant over the configured grant, and antenna recycling component 352 can drop the CG-PUSCH on CC 0. In another example, prioritization rules can indicate to prioritize grants based on serving cell index (e.g., prioritize grants for lower serving cell indices), based on channel type (e.g., prioritize downlink or uplink, prioritize dynamically scheduled PDSCH or SPS PDSCH or CG-PUSCH or PUCCH, etc.), based on content carried by a channel (e.g., whether PUSCH has UCI or not, or what type of UCI the PUSCH is transmitting, etc.), and/or the like. The rules can be configured in the UE 104 based on the wireless communication technology standard (e.g., 5G NR), configured via configuration or other signaling from the network node, etc.

Accordingly, in some examples, the network node can similarly perform communications based on the same prioritization rule. In method 1000, at Block 1006, at least one of the first communications or the second communications can be performed based on a prioritization rule. In an aspect, BS communicating component 442, e.g., in conjunction with processor(s) 412, memory/memories 416, transceiver 402, etc., can perform, based on the prioritization rule, at least one of the first communications or the second communications. For example, BS communicating component 442 can employ the prioritization rule to determine when the antenna switching conflicts with the first communications over the SPS or CG resources at the UE 104, and can accordingly perform the first and/or second communications with the UE 104.

In one example, in performing the communications based on the prioritization rule at Block 906, optionally at Block 908, the second communications can be prioritized based at least in part on downgrading the first communications to use a less number of antennas. In an aspect, antenna recycling component 352, e.g., in conjunction with processor(s) 312, memory/memories 316, transceiver 302, UE communicating component 342, etc., can prioritize the second communications based at least in part on downgrading the first communications to use the less number of antennas. For example, the UE can perform prioritization and instead of dropping, downgrade the number of transmit and/or receive antennas. For example, if a CG is configured originally CC 0 with two transmit antennas and 2 layers, but based on a grant, antenna recycling component 352 shares some of the antennas with CC 1 resulting in one transmit antenna and one layer for CC 0, UE communicating component 342 can transmit in CC 0 using the single transmit antenna and single layer. This downgrade of transmit and/or receive antennas, allowed cases, and time patterns (if such patterns exists) can be aligned between UE and gNB. Thus, for example, the network node may signal the downgrade (or related parameters), allowed cases, and/or time patterns to the UE 104 (e.g., in dynamic or semi-static signaling), or the same can be requested first by the UE.

Accordingly, in some examples, the network node can similarly prioritize the second communications by downgrading the first communications. In method 1000, optionally at Block 1008, the second communications can be prioritized based at least in part on downgrading the first communications to use a less number of antennas. In an aspect, BS communicating component 442, e.g., in conjunction with processor(s) 412, memory/memories 416, transceiver 402, etc., can prioritize the second communications based at least in part on downgrading the first communications to use the less number of antennas, as described above.

FIG. 11 is a block diagram of a MIMO communication system 1100 including a base station 102 and a UE 104. The MIMO communication system 1100 may illustrate aspects of the wireless communication access network 100 described with reference to FIG. 1. The base station 102 may be an example of aspects of the base station 102 described with reference to FIG. 1. The base station 102 may be equipped with antennas 1134 and 1135, and the UE 104 may be equipped with antennas 1152 and 1153. In the MIMO communication system 1100, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 1120 may receive data from a data source. The transmit processor 1120 may process the data. The transmit processor 1120 may also generate control symbols or reference symbols. A transmit MIMO processor 1130 may perform spatial processing (e.g., precoding) on data symbols, control symbols, or reference symbols, if applicable, and may provide output symbol streams to the transmit modulator/demodulators 1132 and 1133. Each modulator/demodulator 1132 through 1133 may process a respective output symbol stream (e.g., for OFDM, etc.) to obtain an output sample stream. Each modulator/demodulator 1132 through 1133 may further process (e.g., convert to analog, amplify, filter, and upconvert) the output sample stream to obtain a DL signal. In one example, DL signals from modulator/demodulators 1132 and 1133 may be transmitted via the antennas 1134 and 1135, respectively.

The UE 104 may be an example of aspects of the UEs 104 described with reference to FIGS. 1 and 3. At the UE 104, the UE antennas 1152 and 1153 may receive the DL signals from the base station 102 and may provide the received signals to the modulator/demodulators 1154 and 1155, respectively. Each modulator/demodulator 1154 through 1155 may condition (e.g., filter, amplify, downconvert, and digitize) a respective received signal to obtain input samples. Each modulator/demodulator 1154 through 1155 may further process the input samples (e.g., for OFDM, etc.) to obtain received symbols. A MIMO detector 1156 may obtain received symbols from the modulator/demodulators 1154 and 1155, perform MIMO detection on the received symbols, if applicable, and provide detected symbols. A receive (Rx) processor 1158 may process (e.g., demodulate, deinterleave, and decode) the detected symbols, providing decoded data for the UE 104 to a data output, and provide decoded control information to a processor(s) 1180, or memory/memories 1182.

The processor(s) 1180 may in some cases execute stored instructions to instantiate a UE communicating component 342 (see e.g., FIGS. 1 and 3).

On the uplink (UL), at the UE 104, a transmit processor 1164 may receive and process data from a data source. The transmit processor 1164 may also generate reference symbols for a reference signal. The symbols from the transmit processor 1164 may be precoded by a transmit MIMO processor 1166 if applicable, further processed by the modulator/demodulators 1154 and 1155 (e.g., for single carrier-FDMA, etc.), and be transmitted to the base station 102 in accordance with the communication parameters received from the base station 102. At the base station 102, the UL signals from the UE 104 may be received by the antennas 1134 and 1135, processed by the modulator/demodulators 1132 and 1133, detected by a MIMO detector 1136 if applicable, and further processed by a receive processor 1138. The receive processor 1138 may provide decoded data to a data output and to the processor(s) 1140 or memory/memories 1142.

The processor(s) 1140 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 1100. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 1100.

The following aspects are illustrative only and aspects thereof may be combined with aspects of other embodiments or teaching described herein, without limitation.

Aspect 1 is a method for wireless communication at a UE including receiving a configuration for a first antenna of the UE to receive downlink signaling in a first band, receiving, from a network node, an indication to use the first antenna, during a time period, along with a second antenna of the UE to receive downlink signaling in a second band, and receiving, during the time period, downlink signaling in the second band using the first antenna and the second antenna.

In Aspect 2, the method of Aspect 1 includes where the indication includes a semi-static indication to use the first antenna to receive downlink signaling in the second band according to a configured pattern of time periods.

In Aspect 3, the method of any of Aspects 1 or 2 includes where receiving the indication includes receiving, from the network node, a downlink grant that includes the indication.

In Aspect 4, the method of Aspect 3 includes where the time period corresponds to time resources specified in the downlink grant.

In Aspect 5, the method of any of Aspects 3 or 4 includes where the time period corresponds to a duration of time until another downlink grant is received that indicates to use the first antenna to receive downlink signaling in a band other than the second band.

In Aspect 6, the method of any of Aspects 3 to 5 includes where the time period corresponds to an observation period of a subset of slots.

In Aspect 7, the method of any of Aspects 3 to 6 includes where the time period begins at a time after feedback is transmitted for a received downlink communication.

In Aspect 8, the method of Aspect 7 includes where receiving downlink signaling in the second band using the first antenna is based on transmitting the feedback as including an acknowledgement.

In Aspect 9, the method of any of Aspects 3 to 8 includes where the downlink grant is received in DCI or MAC-CE.

In Aspect 10, the method of any of Aspects 1 to 9 includes receiving, from the network node, a reference signal configuration indicating a number of antennas to use for performing reference signal measurements, and transmitting, to the network node, reference signal measurements performed using the number of antennas.

In Aspect 11, the method of Aspect 10 includes where the reference signal configuration indicates to use at least the first antenna and the second antenna for measuring CSI-RSs for reporting CSI for the second band.

In Aspect 12, the method of Aspect 11 includes where the reference signal configuration indicates the number of antennas is per one or more of a CSI reporting configuration, a resource setting, or a resource.

In Aspect 13, the method of any of Aspects 1 to 12 includes where receiving the indication includes receiving, from the network node, a downlink grant that includes the indication and a second indication of a number of antennas to use for measuring CSI-RSs for reporting CSI for the second band.

In Aspect 14, the method of Aspect 13 includes where receiving the second indication is at a beginning of an observation period of a subset of slots.

In Aspect 15, the method of any of Aspects 13 or 14 includes where the time period corresponds to a switching gap after receiving the downlink grant.

In Aspect 16, the method of any of Aspects 1 to 15 includes receiving, in a RRC configuration for a configured grant corresponding to the downlink signaling in the second band, a second indication of a number of antennas to use for measuring CSI-RSs for reporting CSI for the second band.

In Aspect 17, the method of any of Aspects 1 to 16 includes determining a number of antennas used for measuring CSI-RSs for reporting CSI for the second band to include at least the first antenna and the second antenna based at least in part on a time pattern.

In Aspect 18, the method of Aspect 17 includes receiving, from the network node, an indication of the time pattern in RRC signaling configuring resources for the downlink signaling.

Aspect 19 is a method for wireless communication at a UE including receiving one or more configurations indicating resources for transmitting SRSs to a network node in a first band using each of multiple combinations of multiple antennas, where at least one combination of the multiple combinations is based on switching one or more of the multiple antennas that are configured for a second band to the first band, and transmitting, to the network node and using at least one of the multiple combinations, a SRS in the first band based on switching the one or more of the multiple antennas that are configured for the second band for use in the first band.

In Aspect 20, the method of Aspect 19 includes where the one or more configurations includes a single configuration that indicates each of the multiple combinations, and receiving, from the network node, an indication of the at least one of the multiple combinations to use to transmit the SRS.

In Aspect 21, the method of any of Aspects 19 or 20 includes where the one or more configurations include one configuration for each of the multiple combinations, and receiving, from the network node, an indication of at least one configuration to use to transmit the SRS.

In Aspect 22, the method of any of Aspects 19 to 21 includes where the one or more configurations indicate one or more of an SRS port, SRS resources, or SRS sets corresponding to each of the multiple combinations.

In Aspect 23, the method of any of Aspects 19 to 22 includes receiving, from the network node, downlink control information indicating the at least one of the multiple combinations to use to transmit the SRS.

In Aspect 24, the method of any of Aspects 19 to 23 includes selecting the at least one of the multiple combinations based on a semi-static pattern.

In Aspect 25, the method of any of Aspects 19 to 24 includes selecting the at least one of the multiple combinations based on an indicated preference for a portion of the multiple antennas that are associated with the one of the multiple combinations.

In Aspect 26, the method of any of Aspects 19 to 25 includes transmitting, to the network node, a report indicating, for each of the first band and the second band, a number of transmit antennas and a number of receive antennas that can be configured, and whether, for a band pair of the first band and the second band, receive antenna switching, transmit antenna switching, or both are supported, where receiving the one or more configurations is based on the report.

In Aspect 27, the method of Aspect 26 includes where the one or more configurations include a configuration per combination of the number of transmit antennas and the number of receive antennas that can be configured for each of the first band and the second band.

In Aspect 28, the method of any of Aspects 19 to 27 includes where transmitting the SRS signaling is performed using an increased power based on a subset of SRS ports indicated in the configuration.

Aspect 29 is a method for wireless communication at a network node including transmitting, for a UE, a configuration indicating a first antenna of the UE to receive downlink signaling in a first band, and transmitting, to the UE, an indication to use the first antenna, during a time period, along with a second antenna of the UE to receive downlink signaling in a second band.

In Aspect 30, the method of Aspect 29 includes where the indication includes a semi-static indication to use the first antenna to receive downlink signaling in the second band according to a configured pattern of time periods.

In Aspect 31, the method of any of Aspects 29 or 30 includes where receiving the indication includes receiving, from the network node, a downlink grant that includes the indication.

In Aspect 32, the method of Aspect 31 includes where the time period corresponds to time resources specified in the downlink grant.

In Aspect 33, the method of any of Aspects 31 or 32 includes where the time period corresponds to a duration of time until another downlink grant is transmitted that indicates to use the first antenna to receive downlink signaling in a band other than the second band.

In Aspect 34, the method of any of Aspects 31 to 33 includes where the time period corresponds to an observation period of a subset of slots.

In Aspect 35, the method of any of Aspects 31 to 34 includes where the time period begins at a time after feedback is received for a downlink communication.

In Aspect 36, the method of any of Aspects 31 to 35 includes where the downlink grant is transmitted in DCI or MAC-CE.

In Aspect 37, the method of any of Aspects 29 to 36 includes transmitting, to the UE, a reference signal configuration indicating a number of antennas to use for performing reference signal measurements, and receiving, from the UE, reference signal measurements performed using the number of antennas.

In Aspect 38, the method of Aspect 37 includes where the reference signal configuration indicates to use at least the first antenna and the second antenna for measuring CSI-RSs for reporting CSI for the second band.

In Aspect 39, the method of Aspect 38 includes where the reference signal configuration indicates the number of antennas is per one or more of a CSI reporting configuration, a resource setting, or a resource.

In Aspect 40, the method of any of Aspects 29 to 39 includes where transmitting the indication includes transmitting, to the UE, a downlink grant that includes the indication and a second indication of a number of antennas to use for measuring CSI-RSs for reporting CSI for the second band.

In Aspect 41, the method of Aspect 40 includes where transmitting the second indication is at a beginning of an observation period of a subset of slots.

In Aspect 42, the method of any of Aspects 40 or 41 includes where the time period corresponds to a switching gap after transmitting the downlink grant.

In Aspect 43, the method of any of Aspects 29 to 42 includes transmitting, in a RRC configuration for a configured grant corresponding to the downlink signaling in the second band, a second indication of a number of antennas to use for measuring CSI-RSs for reporting CSI for the second band.

In Aspect 44, the method of any of Aspects 29 to 43 includes transmitting, to the UE, an indication of a time pattern in RRC signaling configuring resources for the downlink signaling, and receiving, from the UE, measurements of CSI-RSs for the second band using a number of antennas that is based on the time pattern.

Aspect 45 is a method for wireless communication at a network node including transmitting, for a UE, one or more configurations indicating resources for transmitting SRSs in a first band using each of multiple combinations of multiple antennas, where at least one combination of the multiple combinations is based on switching one or more of the multiple antennas that are configured for a second band to the first band, and receiving, from the UE, a SRS in the first band, where the SRS is based on the at least one of the multiple combinations.

In Aspect 46, the method of Aspect 45 includes where the one or more configurations includes a single configuration that indicates each of the multiple combinations, and transmitting, for the UE, an indication of the at least one of the multiple combinations to use to transmit the SRS.

In Aspect 47, the method of any of Aspects 45 or 46 includes where the one or more configurations include one configuration for each of the multiple combinations, and transmitting, for the UE, an indication of at least one configuration to use to transmit the SRS.

In Aspect 48, the method of any of Aspects 45 to 47 includes where the one or more configurations indicate one or more of an SRS port, SRS resources, or SRS sets corresponding to each of the multiple combinations.

In Aspect 49, the method of any of Aspects 45 to 48 includes transmitting, to the UE, downlink control information indicating the at least one of the multiple combinations to use to transmit the SRS.

In Aspect 50, the method of any of Aspects 45 to 49 includes where the at least one of the multiple combinations is based on a semi-static pattern.

In Aspect 51, the method of any of Aspects 45 to 50 includes where the at least one of the multiple combinations is based on an indicated preference on antennas associated to which SRS to use.

In Aspect 52, the method of any of Aspects 45 to 51 includes receiving, for the UE, a report indicating, for each of the first band and the second band, a number of transmit antennas and a number of receive antennas that can be configured, and whether, for a band pair of the first band and the second band, receive antenna switching, transmit antenna switching, or both are supported, where transmitting the one or more configurations is based on the report.

In Aspect 53, the method of Aspect 52 includes where the one or more configurations include a configuration per combination of the number of transmit antennas and the number of receive antennas that can be configured for each of the first band and the second band.

Aspect 54 is a method for wireless communication at a UE including receiving, from a network node, a configuration indicating SPS or CG resources for first communications on a first band in a time period, receiving, from a network node, an indication to perform antenna switching of at least a portion of multiple antennas from the first band to a second band to perform second communications in the time period, and performing, with the network node and based on a prioritization rule, at least one of the first communications or the second communications.

In Aspect 55, the method of Aspect 54 includes where the indication to perform antenna switching is received in a scheduling grant for the second communications.

In Aspect 56, the method of any of Aspects 54 or 55 includes where performing at least one of the first communications or the second communications includes performing one of the first communications or the second communications and refraining from performing the other one of the first communications or the second communications.

In Aspect 57, the method of Aspect 56 includes where the prioritization rule indicates to prioritize communications based on dynamic grant or configured grant, based on a channel type, based on a serving cell index, or based on a content carried by the communications.

In Aspect 58, the method of any of Aspects 54 to 57 includes where the prioritization rule indicates to downgrade the first communications to use a less number of antennas based on the indication, and where performing at least one of the first communications or the second communications include performing the first communications using the less number of antennas and performing the second communications using at least the portion of multiple antennas switched to the second band.

Aspect 59 is a method for wireless communication at a network node including transmitting, for a UE, a configuration indicating SPS or CG resources for first communications on a first band in a time period, transmitting, for the UE, an indication to perform antenna switching of at least a portion of multiple antennas from the first band to a second band to perform second communications in the time period, and performing, with the UE and based on a prioritization rule, at least one of the first communications or the second communications.

In Aspect 60, the method of Aspect 59 includes where the indication to perform antenna switching is received in a scheduling grant for the second communications.

In Aspect 61, the method of any of Aspects 59 or 60 includes where performing at least one of the first communications or the second communications includes performing one of the first communications or the second communications and refraining from performing the other one of the first communications or the second communications.

In Aspect 62, the method of Aspect 61 includes where the prioritization rule indicates to prioritize communications based on dynamic grant or configured grant, based on a channel type, based on a serving cell index, or based on a content carried by the communications.

In Aspect 63, the method of any of Aspects 59 to 62 includes where the prioritization rule indicates to downgrade the first communications to use a less number of antennas based on the indication, and where performing at least one of the first communications or the second communications include performing the first communications based on the UE using the less number of antennas and performing the second communications based on the UE using at least the portion of multiple antennas switched to the second band.

Aspect 64 is an apparatus for wireless communication including one or more processors, one or more memories coupled with the one or more processors, and instructions stored in the one or more memories and operable, when executed by the one or more processors, to cause the apparatus to perform any of the methods of Aspects 1 to 63.

Aspect 65 is an apparatus for wireless communication including means for performing any of the methods of Aspects 1 to 63.

Aspect 66 is one or more computer-readable media including code executable by one or more processors for wireless communications, the code including code for performing any of the methods of Aspects 1 to 63.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive a configuration for a first antenna of the apparatus to receive downlink signaling in a first band;
receive, from a network node, an indication to use the first antenna, during a time period, along with a second antenna of the apparatus to receive downlink signaling in a second band; and
receive, during the time period, downlink signaling in the second band using the first antenna and the second antenna.

2. The apparatus of claim 1, wherein the indication includes a semi-static indication to use the first antenna to receive downlink signaling in the second band according to a configured pattern of time periods.

3. The apparatus of claim 1, wherein the one or more processors are, individually or in combination, configured to execute the instructions to cause the apparatus to receive the indication from the network node in a downlink grant.

4. The apparatus of claim 3, wherein the time period corresponds to time resources specified in the downlink grant.

5. The apparatus of claim 3, wherein the time period corresponds to a duration of time until another downlink grant is received that indicates to use the first antenna to receive downlink signaling in a band other than the second band.

6. The apparatus of claim 3, wherein the time period corresponds to an observation period of a subset of slots.

7. The apparatus of claim 3, wherein the time period begins at a time after feedback is transmitted for a received downlink communication.

8. The apparatus of claim 7, wherein the one or more processors are, individually or in combination, configured to execute the instructions to cause the apparatus to receive the downlink signaling in the second band using the first antenna based on transmitting the feedback as including an acknowledgement.

9. The apparatus of claim 3, wherein the downlink grant is received in downlink control information (DCI) or media access control (MAC)-control element (CE).

10. The apparatus of claim 1, wherein the one or more processors are, individually or in combination, configured to execute the instructions to cause the apparatus to:
receive, from the network node, a reference signal configuration indicating a number of antennas to use for performing reference signal measurements; and
transmit, to the network node, reference signal measurements performed using the number of antennas.

11. The apparatus of claim 10, wherein the reference signal configuration indicates to use at least the first antenna and the second antenna for measuring channel state information (CSI)-reference signals (RSs) for reporting CSI for the second band.

12. The apparatus of claim 11, wherein the reference signal configuration indicates the number of antennas is per one or more of a CSI reporting configuration, a resource setting, or a resource.

13. The apparatus of claim 1, wherein the one or more processors are, individually or in combination, configured to execute the instructions to cause the apparatus to receive the indication from the network node in a downlink grant and a second indication of a number of antennas to use for measuring channel state information (CSI)-reference signals (RSs) for reporting CSI for the second band.

14. The apparatus of claim 13, wherein the one or more processors are, individually or in combination, configured to execute the instructions to cause the apparatus to receive the second indication at a beginning of an observation period of a subset of slots.

15. The apparatus of claim 13, wherein the time period corresponds to a switching gap after receiving the downlink grant.

16. The apparatus of claim 1, wherein the one or more processors are, individually or in combination, configured to execute the instructions to cause the apparatus to receive, in a radio resource control (RRC) configuration for a configured grant corresponding to the downlink signaling in the second band, a second indication of a number of antennas to use for measuring channel state information (CSI)-reference signals (RSs) for reporting CSI for the second band.

17. The apparatus of claim 1, wherein the one or more processors are, individually or in combination, configured to execute the instructions to cause the apparatus to determine a number of antennas used for measuring channel state information (CSI)-reference signals (RSs) for reporting CSI for the second band to include at least the first antenna and the second antenna based at least in part on a time pattern.

18. The apparatus of claim 17, wherein the one or more processors are, individually or in combination, configured to execute the instructions to cause the apparatus to receive, from the network node, an indication of the time pattern in radio resource control (RRC) signaling configuring resources for the downlink signaling.

19. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive one or more configurations indicating resources for transmitting sounding reference signals (SRSs) to a network node in a first band using each of multiple combinations of multiple antennas, wherein at least one combination of the multiple combinations is based on switching one or more of the multiple antennas that are configured for a second band to the first band; and
transmit, to the network node and using at least one of the multiple combinations, a SRS in the first band based on switching the one or more of the multiple antennas that are configured for the second band for use in the first band.

20. The apparatus of claim 19, wherein the one or more configurations includes a single configuration that indicates each of the multiple combinations, and wherein the one or more processors are, individually or in combination, configured to execute the instructions to cause the apparatus to receive, from the network node, an indication of the at least one of the multiple combinations to use to transmit the SRS.

21. The apparatus of claim 19, wherein the one or more configurations include one configuration for each of the multiple combinations, and wherein the one or more processors are, individually or in combination, configured to execute the instructions to cause the apparatus to receive, from the network node, an indication of at least one configuration to use to transmit the SRS.

22. The apparatus of claim 19, wherein the one or more configurations indicate one or more of an SRS port, SRS resources, or SRS sets corresponding to each of the multiple combinations.

23. The apparatus of claim 19, wherein the one or more processors are, individually or in combination, configured to execute the instructions to cause the apparatus to receive, from the network node, downlink control information indicating the at least one of the multiple combinations to use to transmit the SRS.

24. The apparatus of claim 19, wherein the one or more processors are, individually or in combination, configured to execute the instructions to cause the apparatus to select the at least one of the multiple combinations based on a semi-static pattern.

25. The apparatus of claim 19, wherein the one or more processors are, individually or in combination, configured to execute the instructions to cause the apparatus to select the at least one of the multiple combinations based on an indicated preference for a portion of the multiple antennas that are associated with the one of the multiple combinations.

26. The apparatus of claim 19, wherein the one or more processors are, individually or in combination, configured to execute the instructions to cause the apparatus to transmit, to the network node, a report indicating, for each of the first band and the second band, a number of transmit antennas and a number of receive antennas that can be configured, and whether, for a band pair of the first band and the second band, receive antenna switching, transmit antenna switching, or both are supported, wherein the one or more processors are, individually or in combination, configured to execute the instructions to cause the apparatus to receive the one or more configurations based on the report.

27. The apparatus of claim 26, wherein the one or more configurations include a configuration per combination of the number of transmit antennas and the number of receive antennas that can be configured for each of the first band and the second band.

28. The apparatus of claim 19, wherein the one or more processors are, individually or in combination, configured to execute the instructions to cause the apparatus to transmit the SRS signaling using an increased power based on a subset of SRS ports indicated in the configuration.

29. A method for wireless communication at a user equipment (UE), comprising:
receiving a configuration for a first antenna of the UE to receive downlink signaling in a first band;
receiving, from a network node, an indication to use the first antenna, during a time period, along with a second antenna of the UE to receive downlink signaling in a second band; and
receiving, during the time period, downlink signaling in the second band using the first antenna and the second antenna.

30. A method for wireless communication at a user equipment (UE), comprising:
receiving one or more configurations indicating resources for transmitting sounding reference signals (SRSs) to a network node in a first band using each of multiple combinations of multiple antennas, wherein at least one combination of the multiple combinations is based on switching one or more of the multiple antennas that are configured for a second band to the first band; and
transmitting, to the network node and using at least one of the multiple combinations, a SRS in the first band based on switching the one or more of the multiple antennas that are configured for the second band for use in the first band.
